(19) United States
(12) Patent Application Publication
(10) Pub. No.: US 2016/0035038 A1
(43) Pub. Date: Feb. 4, 2016

(54) CLAIM PROCESSING SYSTEM FOR TEMPORARY HOUSING CLAIMS

(71) Applicant: Loss of Use, Inc., Huntersville, NC (US)

(72) Inventor: Brenda Lou Perkins, Statesville, NC (US)

(73) Assignee: Loss of Use, Inc.

(21) Appl. No.: 14/814,493

(22) Filed: Jul. 30, 2015

Related U.S. Application Data
(60) Provisional application No. 62/030,922, filed on Jul. 30, 2014.

(51) Int. Cl. G06Q 40/08

(52) U.S. Cl. CPC G06Q 40/08

(57) ABSTRACT

A claims processing system for processing an insurance claim for a housing property loss insured by an insurer including a controller, a memory in communication with the controller, the memory including instructions that cause the controller to: receive a claim, the claim including claim parameters including an anticipated lease term, a location related to an insured loss, a loss value, and a number of people to be housed; identify a pool of acceptable housing accommodations matching within a range for each of the claim parameters; select a housing accommodation from the pool of acceptable housing accommodations; receive a vendor invoice from a vendor providing the selected housing accommodation including: an amount due, a retail rate, and a discounted rate; and receive confirmation of receipt of payment from the insurer corresponding to the amount due and a portion of the difference between the retail rate and the discounted rate.

### CROSS-REFERENCE TO RELATED APPLICATIONS

This application incorporates by reference and claims the benefit of priority to U.S. Provisional Patent Application No. 62/030,922 filed Jul. 30, 2014.

### BACKGROUND OF THE INVENTION

The present subject matter relates generally to a claim processing system for temporary housing claims. More specifically, the present invention relates to a claims processing system for temporary housing claims to eliminate the mark-up caused by middlemen, such as temporary housing suppliers, by providing software platforms for managing the temporary housing claims transparently using outside hotel and housing contractors.

Indemnity is the act of making someone “whole” (give equal to what they have lost or protected from (insured against) any loses they have incurred. Indemnity insurance compensates the beneficiaries of the policies for their actual economic losses, up to the limiting amount of the insurance policy. It generally requires the insured to prove the amount of its loss before it can recover. Recovery is limited to the amount of the provable loss even if the face amount of the policy is higher.

Prior to 1980 the P&C Insurer offered no assistance to their policyholders who needed temporary housing due to their loss. Realizing that this was an overwhelming undertaking for their insured, the P&C Insurers decided to offer a service to assist their insured. To accomplish this they teamed up with the temporary housing industry to facilitate Schedule D claims—additional living expenses.

However, the P&C Industry did not perform due diligence on the costs of temporary housing. Consequently the P&C Industry has been overcharged by millions of dollars by their temporary housing suppliers over the last 30 years in inflated loss expense payouts—artificially increasing their risk liability.

The temporary housing industry is a part of the hotel industry that emerged as an alternative to hotels for corporate America's need to relocate employees for short-term assignments. A temporary housing supplier, a middleman retailer, rents goods and services from various vendors, marks up original retail costs to cover their overhead and their desired profit and then rents (subleases) the fully furnished temporary dwelling to the policyholder/P&C Insurer for one all-inclusive price.

The cost-plus business model used by the temporary housing industry works for corporate businesses that spend money as an investment full expecting an ROI. However, with the P&C Industry all money spent is a loss expense; therefore, controlling actual costs is of paramount importance.

Another challenge for the P&C Insurer is that the market for suppliers in claims is extremely diverse, complex and far more fragmented than other P&C Industry wide spend categories. Further, ultimate control and buying decisions reside with the insured, which requires a different approach than most spend management strategies. The suppliers are also embedded deeply into many of the core processes—which can blur the line between supplier and process management.

According to Deliotte in a 2010 article, Driving Operational Excellence in Claims Management, “One of the biggest operational challenges is a lack of analytical insight; most insurers are simply unaware of what their suppliers are costing them. These challenges can result in:
Limited visibility, control and tracking of supplier spending.
Inconsistent supplier performance.
Lack of knowledge of suppliers, resulting in increased risk.

The sheer size of the spend demands concerted attention and a thoughtful strategy.”

The temporary housing industry whose financial infrastructure is built on the cost-plus business model is the P&C Industry's current solution. With the retail business model, the original cost of all goods & services is proprietary to the retailer so they can markup and then retail for an undisclosed profit. This is possible because each temporary housing supplier is a middleman retailer. It obtains the goods at the actual incurred retail cost from the vendor; then goes through the same markup process to arrive at a retail price that is now an artificially inflated retail cost. It then bills the artificially inflated cost of vendor goods and services to the P&C Insurer as actual incurred cost.

Additionally, there was previously no supplier data management system designed specifically to process and manages claims data in the Schedule D Loss Category for the P&C Indemnity Insurance Industry that can be integrated with the P&C Insurer's technology.

There was a previous attempt to solve the problem of temporary housing overbilling. In 2009, the P&C Insurance Industry created and implemented the Monthly Management Fee Supplier Management Strategy aimed at controlling Schedule D (Additional Living Expenses) payouts. Supplier contracts were awarded based on monthly management fee schedules submitted by the temporary housing suppliers. The contracted suppliers were then given exclusivity—a Preferred Supplier status.

Accordingly, adjusters were not allowed to refer a policyholder to a supplier who was not one of the company's contracted Preferred Suppliers. For example, with Nationwide Insurance these Preferred Suppliers are called “OYS”—On Your Side Suppliers.

In short, under Preferred Supplier status, the insurer would increase the overall claims volume of the Preferred Supplier by eliminating supplier competition and paying them an agreed upon monthly fee to manage the claim in exchange for the Preferred Vendor's agreement to not markup the original vendor's costs of goods and services.

The monthly management fee strategy demonstrates that the P&C Insurance Industry does not understand the temporary housing industry's business model that is the based on the cost-plus business model. With the monthly management fee contracts the P&C Industry accomplished the exact opposite of their desired solution—to pay out actual provable economic losses to the policyholder plus give them a service to help with their relocation process after the loss of their home. Instead, under the monthly management fee strategy the temporary housing suppliers still entered into the rental contracts with the vendors of goods and services then subleasing to the policyholder. Accordingly, it was still possible for temporary housing suppliers to mark up costs, and with this strategy the P&C Industry created a monopoly for the preferred suppliers.

The major flaw in these contracts was that they acknowledged their temporary housing supplier's proprietary rights to the original costs of vendor goods and services by requiring them to “list” not document the original cost on their invoices. The supplier was able, therefore, to make the costs be whatever they need them to be to support the amount of the invoice. Thus, analytical insight into the policyholder's actual incurred costs was still totally blocked.

Further, prior to 2009 and the monthly management fee contracts, the temporary housing industry took every precaution to make sure that the cost of all goods and services were totally proprietary which meant that any and all leases were in the name of the supplier. It was believed vital to conceal the fact that the markup on retail goods and services was a minimum of 25% per month.

However, these precautions became considered no longer necessary once suppliers became Preferred Suppliers. The Preferred Suppliers then began requiring the insured to sign the dwelling lease—a liability risk management strategy for the supplier against damages caused by the insured. Because of their protected status as preferred suppliers, the suppliers began boldly adding their desired markup on non-proprietary retail cost as well as their proprietary cost and billing that total amount to the P&C Insurer as their actual incurred cost.

Additionally, under monthly management fee contracts it was impossible to put effective controls into place to monitor the accuracy of the billing contract or the success of the strategy. Because of the need to hide the markup on the provided services, temporary housing suppliers were reluctant to tie their systems to closely to the insurers business systems. If they were to integrate their technology systems with the insurer's technology systems they would have to create, in essence, two completely different sets of books lest they expose that they are in violation of their monthly management fee contract by exposing their continued markup on the vendor's original cost of goods and services. Additionally, the cost to create two separate systems would be very costly and the operational challenges would be daunting. Accordingly, there is still a need for systems for processing temporary housing claims that integrate with insurer's technology systems.

Accordingly, there is a need for a claims processing system for temporary housing claims to remove the costly markup of temporary housing suppliers, by providing software platforms for managing the temporary housing claims, as described herein.

### BRIEF SUMMARY OF THE INVENTION

To meet the needs described above and others, the present disclosure provides a claims processing system for temporary housing claims that is a P&C Insurance Industry specific proprietary “supplier” data processing system for receiving, collecting, recording, storing, monitoring and reporting information necessary to process Schedule D claims.

The claims processing system is comprised of multiple custom designed software modules all interfaced with each other operating with a wide range of functionality inside each individual claim. Therefore, no 3rd Party software platforms such as Quick Books need to be integrated into the claims processing system to process the claim. The custom software modules may communicate with a central database to coordinate the claims process.

In an embodiment, the claims processing system may be provided as a claims processing software application that may be executed on a standard personal computer, such as a personal computer running the Windows operating system. In use, the claims processing software application directs the personal computer to communicate with a central server to permit coordinated efforts between users of the application. Multiple users may use the claims processing system, each having a different role, in order to carry out the claims process. The claims processing software application may additionally communicate with P&C organization computers to affect the goals described herein.

The claims processing system provides a 360-degree view of the entire Schedule D claim lifecycle within each individual claim start to finish. The claims processing system also tracks all relative financial data for each individual claim as well as total claims by zip codes, by county, by state, by manager or any requested configuration by a client. This enables the P&C Underwriting organization to utilize leading real time cost indicators not lagging or coincidental indicators based on artificially inflated costs when making financial forecasts and decisions such as setting rate adequacies or investment decisions.

The claims processing system may be remotely accessed with assigned (limited or full) user rights that vary based on a user's role in the claims processing system. Additionally, the claims processing system can be integrated with the insurer's core legacy technology systems and/or their new open architecture technology systems. This integration may offer the P&C Insurer a 360-degree overview of all 4 Loss Expense Spend Categories (Schedule A, B, C, and D).

In an embodiment, the claims processing system may include a “shared cost of services” functionality to comply with requirements set forth in the indemnity contract with their policyholder by providing compensation to the beneficiaries of the policies for their actual economic losses with the amount limited to the provable loss amount.

Additionally, in an embodiment, the claims processing system may include “shared savings” functionality. Experience has shown that by leveraging the buying power of our partners with certain providers of goods and services to negotiate discounts to bring the costs below street rate. Under the shared savings functionality, the savings generated by the buying power of the claims processing system is shared between the claims processing system and the insurance company.

In an embodiment, each individual vendor retails their product directly to the insured—all leases are between the vendor and the insured. The insurer pays actual documented provable incurred economic losses not artificially inflated economic losses. In an embodiment, provable incurred economic losses may be shown by attaching all original vendor invoices and all original leases to the adjuster's invoice with no alterations. In another embodiment, provable incurred economic losses may be shown by receiving payment credentials of the insurer, such as a credit card, and making all vendor payments using the payment credentials. Additionally, in an embodiment, the adjuster or the insurance company may additionally be provided an audit portal to view the internal bookkeeping entries for the claim in the claim processing system, including images of cancelled checks.

In an embodiment, the claims processing system may solve the problems presented by the cost-plus business model by using alternative revenue streams: 1.) A one-time flat Professional Retainer of $950 may be paid by the insurer to the user regardless of the scope of the assignment, time required or the length of the lease; and 2.) shared savings between the insurer and the claims processing system for any discounts or incentives generated by the claims processing system. With this business method the vendor who benefits from the insurer's claims volume is now offsetting the insurer's existing supplier's cost of services and insurer benefits from the volume of business they bring to the claims processing system.

Additionally, the claims processing system includes a manpower management strategy that would allow users to service the constantly fluctuating claims volume of insurers while keeping operational costs low and providing a superior customer experience.

The claims processing system permits scaling of the workforce to flow with a insurer's unpredictable claims volume by forming two pools of manpower; an internal pool of full time employees and an external pool of independent Hotel/Housing contractors (hereinafter, H/H contractors). The claims processing system utilizes a combination of the two pools, along with manpower standby pools. In an embodiment, the claims processing system permits the coordination of between the internal and external pool of employees.

In an embodiment, the internal standby pool is made up of a customer experience manager (hereinafter, the CEM), an accounting coordinator, and, in some embodiments, a move-out Customer Experience Manager standby candidates that have signed letters of pre-employment just waiting to be called up as a Loss of Use employees. This pool may emphasize motivation, culture compatibility and customer service talent.

In an embodiment, the external Standby pool is made up of Independent H/H contractors. Each H/H contractor may be fully vetted and certified in the claims processing system. The external pool of H/H contractors gives the claims processing system the ability to scale up to handle a few extra hundred or a few 1000 new claims within 24-48 hours—as well as scale down immediately when the volume of claims decreases.

In an embodiment, the H/H contractor's only responsibility in the claims process is to locate hotel and temporary housing; all related administrative duties are handled internally by users using the claims processing system. The Customer Experience Manager (CEM) may assigns claims to H/H Independent Contractors or the H/H contractor may be chosen by rotation from a list. The CEM may track assignments and cross-handle workload from other CEMs. The H/H Independent Contractors may have access to claims assigned to them through a secure login where they may have been granted read, write, update and select rights for specific pages and functions.

When the appropriate hotel and/or temporary housing are located, the H/H submits them to the CEM for acceptance. The CEMs may then present the options to the policyholder who will either approve or reject—this process continues until the policyholder accepts the proposed hotel/housing. Once the policyholder accepts the hotel/housing, the CEM transfers the claim to the furniture rental coordinator and finally to the accounting coordinator to be invoiced. When a claim is invoiced by the accounting coordinator the claims processing system may automatically create a payment due entry on an invoice for the H/H Independent Coordinator. The invoice may be paid by the insurance company directly, or may be paid by the insurer providing payment credentials to the claims processing system to pay on its behalf, or may be paid by the claims processing system on behalf of the insurer. Regardless of payment method, vendor invoices may be provided to the insurer via an adjuster user interface or corporate claims user interface. If the claims processing system has generated any discounts, the insurer may be billed for a portion of the discount under the shared savings model.

The manpower strategy of the described embodiments permits the claims processing system to perform straight through automated claims processing to enhance operational efficiency & effectiveness while keeping operational costs low and providing exceptional customer experience.

In an embodiment, a claims processing system for processing an insurance claim for a housing property loss insured by an insurer includes: a controller; a memory in communication with the controller, the memory including instructions that, when executed by the controller, cause the controller to: receive a claim, the claim including claim parameters including an anticipated lease term, a location related to the housing property loss, a loss value, and a number of people to be housed; identify a pool of acceptable housing accommodations matching within a range for each of the claim parameters; select a housing accommodation from the pool of acceptable housing accommodations; receive a vendor invoice from a vendor providing the selected housing accommodation including: an amount due, a retail rate, and a discounted rate; and receive confirmation of receipt of payment from the insurer corresponding to the amount due and a portion of the difference between the retail rate and the discounted rate.

In some embodiments, the claim is received from a customer experience subsystem. In other embodiments, the claim is received from an adjuster subsystem.

In some embodiments, the claim parameters further include a number of bedrooms, wherein the pool of acceptable housing accommodations includes only housing accommodations including, at a minimum, the number of bedrooms. In some embodiments, the claim parameters further include a number of baths, wherein the pool of acceptable housing accommodations includes only housing accommodations including, at a minimum, the number of baths. In some embodiments, the claim parameters further include a maximum acceptable distance from the location, wherein the pool of acceptable housing accommodations includes only housing accommodations within the maximum acceptable distance from the location.

In some embodiments, the housing accommodations are selected by providing a list to a policyholder and receiving a selection from the policyholder. In some embodiments, the housing accommodations are selected by providing a list to an adjuster and receiving a selection from the adjuster. In some embodiments, the housing accommodations are selected by a best match algorithm. In some embodiments, the housing accommodations are selected on a lowest cost basis. In some embodiments, the housing accommodations are selected on the basis of the shortest distance between the housing accommodation and the location.

In some embodiments, the discounted rate is expressed as a percentage of the retail rate. In some embodiments, the discounted rate is expressed as an absolute number amount.

In some embodiments, the pool of acceptable housing accommodations includes an availability term that is equal to or greater than the lease term. In some embodiments, the location related to the housing property loss is the actual location where the loss occurred. In some embodiments, the location related to the housing property loss is a policyholder selection of a location. In some embodiments, the housing accommodation includes a selection of a hotel and a rental housing.

In an embodiment, a claims processing system for processing an insurance claim for a housing property loss insured by an insurer includes: a housing database including a plurality of housing records, each housing record identifying a rental term, a rental location, a rent amount, and a maximum occupancy; a controller; and a memory in communication with the controller, the memory including instructions that, when executed by the controller, cause the controller to: receive the claim, the claim including claim parameters including a term, a location related to the housing property loss, and a number of persons to be housed; receive payment credentials via an adjuster user interface; calculate a loss value from the housing property loss; identify a pool of acceptable housing accommodations from the housing records matching criteria including the rental term is equal to or greater than the term, the rental location is within a range of the location related to the housing property loss, the number of persons to be housed is less than the maximum occupancy, and the rent is within a range of the loss value; select housing accommodations from the pool of acceptable housing accommodations, the housing accommodates being provided by a vendor; and initiate payment of a payment amount to the vendor using the payment credentials.

In an embodiment, the range of the location related to the housing property loss is up to five miles from the actual location where the loss occurred. In an embodiment, the range of the loss value is a range centered on the loss value of a range amount, wherein the range amount is between zero and five hundred dollars.

An object of the invention is to provide a solution to create a business method and a supporting data management system that would give the P&C Insurance Industry exactly what they needed—to provide an excellent customer experience for their insured while fulfilling the intent of their indemnity contract with the policyholder; by paying actual provable incurred retail cost. Thereby, controlling their primary liability—amounts payable to policyholders who have filed claims for damages.

Another object of the invention is to have a computerized process for the P&C Insurers that delivers a method of monitoring actual incurred cost for Schedule D, additional living expenses, which is one of the four coverage categories in a P&C Claim. Furthermore, it would be desirable for the underwriting organization to have the ability to work from actual incurred cost not artificially inflated cost as they set rate adequacy and making other important internal decisions.

Some advantages of the invention are that it provides:
Leveraging technology to improve the Schedule D Claims loss Category operational efficiency
Providing unobstructed analytical insight into actual supplier costs*
Activate instant sustainable cost reduction starting on the next NOL
Zero costs to the P& C Insurer to implement
Enhancing bottom-line performance
Positive effect on the producer's loss ratio
Reduce—not—grow the percentage of payouts for goods and services
Lower operational cost and enhanced operational efficiency
Providing exceptional customer experience
Adding to higher overall claim service ratings
Enhancing both acquisition and retention rates
Eliminating risk of bad faith lawsuits

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is diagram illustrating an example of a claim processing system.

FIGS. 2A-2H are a flowchart illustrating an example claims processing method that may be executed by the claims processing system of FIG. 1 to process a claim.

FIG. 3 is an example adjuster entry email screen of the claims processing system to permit the adjuster to submit a claim.

FIG. 4 is an example consult screen of the claims processing system to permit a customer experience manager to review the claim.

FIG. 5 is an example wizard screen of the claims processing system to collect information on the hotel needs of the insured persons

FIG. 6 is an example calendar screen of the claims processing system to allow a user to see and create calendar alerts.

FIG. 7 is an example research screen of the claims processing system to permit a user to search options for housing accommodations.

FIG. 8 is an example reservations screen of the claims processing system to display hotel information.

FIG. 9 is an example housing research notes screen of the claims processing system that determines the fair market evaluation.

FIG. 10 is an example vendor screen of the claims processing system to view vendor information in the housing database and research available housing options.

FIG. 11 is an example dwelling screen of the claims processing system to display the housing options under consideration or accepted for a claim.

FIG. 12 is an example housing options screen of the claims processing system illustrating a housing option file that may be sent to an adjuster as a pdf file.

FIG. 13 is an example housing options emails screen of the claims processing system illustrating an email message including an attached housing options file.

FIG. 14 is an example documents screen of the claims processing system including an inventory all documents associated with the claim in the claims database.

FIG. 15 is an example furniture screen of the claims processing system that displays the rental details for the chosen furniture supplier.

FIG. 16 is an example rent screen of the claims processing system to display the rent details for the chosen housing option for a claim.

FIG. 17 is an example invoices screen of the claims processing system to permit an accounting coordinator to invoice transactions relating to a claim to the adjuster.

FIG. 18 is an example deposits screen of the claims processing system to permit the accounting coordinator to track deposits and payments to the claims processing system made on invoices.

FIG. 19 is an example payments screen to track payments to be made to vendors.

FIG. 20 is an example log Notes Screen of the claims processing system that memorializes all of the actions taken for a claim.

FIG. 21 is an example transactions screen of the claims processing system to list all the transactions created for a claim.

FIG. 22 is an example fees screen of the claims processing system to create and view fees for a claim.

FIG. 23 is an example audit screen of the claims processing system for use by an insurance company to audit a claim.

FIG. 24 is another example claims processing method that may be executed by the claims processing system of FIG. 1 to process a claim.

FIG. 25 is yet another example claims processing method that may be executed by the claims processing system of FIG. 1 to process a claim.

### DETAILED DESCRIPTION OF THE INVENTION

As used herein, insured persons 101 mean the policyholder, family members, and other persons for whom the insurance company 107 is providing temporary housing. Adjuster 103 includes the insurance company 107, adjuster 103, independent adjusters 103, public adjusters 103, and may include any employee of the insurance company 107 that uses the claim 352 processing system 100, as may be apparent from the context. Property manager refers collectively and individually to the landlord, property manager, broker, or real estate agent for a temporary housing option.

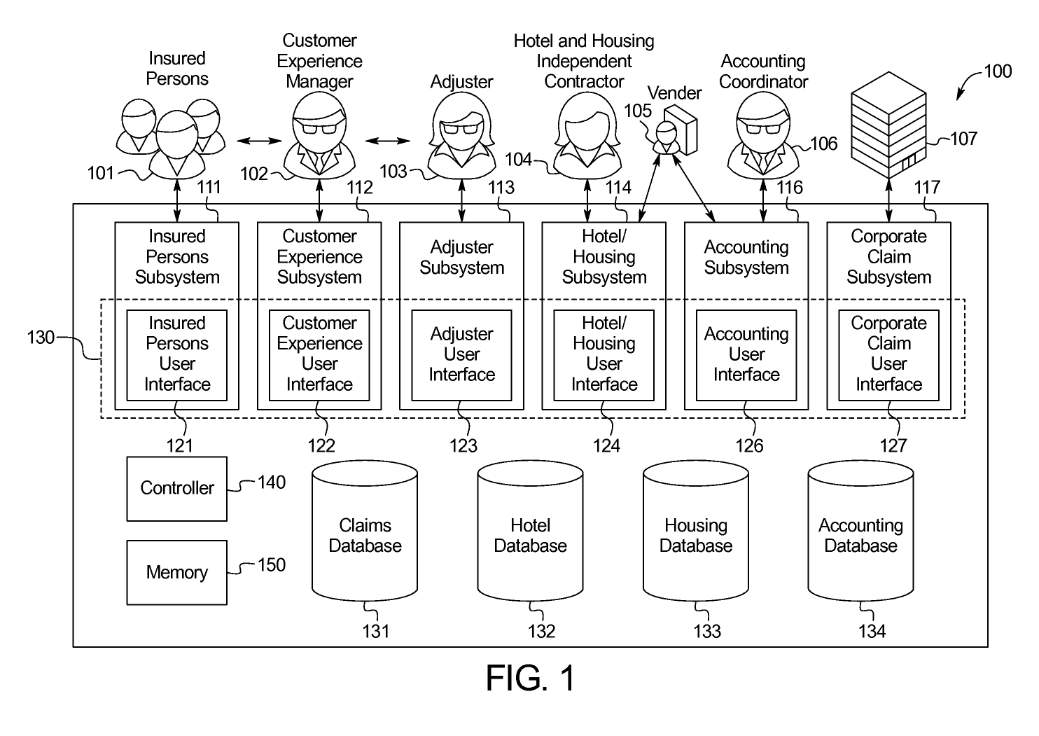

FIG. 1 illustrates an example of a claims processing system 100. As shown in FIG. 1, the claims processing system 100 includes various subsystems to carry out the various tasks of the claims processing system 100 and to communicate with the various people involved in the claims process. The claims process begins when insured persons 101 have a loss. The adjuster 103 may communicate the loss to the claims processing system 100, for example, by contacting a customer experience manager 102 (hereinafter CEM 102). Once a claim 352 has been communicated to the claims processing system 100, the claim 352 may be managed by the customer experience subsystem 112. The customer experience subsystem 112 may delegate various tasks to other subsystems such as the Hotel/Housing subsystem 114, the accounting subsystem 116, etc.

The CEM 102 may interact with the claims processing system 100 via a customer experience user interface 122 of a customer experience subsystem 112. The CEM 102 may be the point of contact between the insured persons 101 and the claims processing system 100, and the point of contact between adjuster 103 and the claims processing system 100. The CEM 102 and the customer experience subsystem 112 may manage the claims process and coordinate the various components of the claims processing system 100. Although various tasks are described herein as being accomplished by the CEM 102 or the customer experience subsystem 112, it is contemplated that any task carried out by the CEM 102 may, in other embodiments, be automatically carried out by the customer experience subsystem 112. In other words, in some embodiments the customer experience subsystem 112 automates every task described herein as being performed by the CEM 102.

In an embodiment, the insured persons 101 may communicate directly with the claims processing system 100 via an insured persons subsystem 111 and the adjuster 103 may communicate with the claims processing system 100 via an adjuster subsystem 113. The insured person subsystem 111 and the adjuster subsystem 113 may provide an insured person user interface 121 and an adjuster user interface 123, respectively. For example, the insured persons user interface 121 and the adjuster user interface 123 may be web-based portals that may be accessed by the insured persons 101 and the adjuster 103 to interact with the claims processing system 100.

In an embodiment, the claims processing system 100 may include a hotel/housing subsystem 114 to manage the search for hotel accommodations and temporary housing for the insured persons 101. The housing/hotel subsystem 114 may include a H/H user interface 124 used by a Housing/Hotel Independent Coordinator 104 (hereinafter, the “H/H coordinator 104”) responsible for the housing and hotel search. The H/H user interface 124 may enable the H/H coordinator 104 to search for hotel and housing options for the insured persons 101. In order to locate hotel accommodations and temporary housing, the housing/hotel subsystem 114 may communicate with vendors 105. Although various tasks are described herein as being accomplished by the H/H coordinator 104 or the housing/hotel subsystem 114, it is contemplated that any task carried out by the H/H coordinator 104 may, in other embodiments, be automatically carried out by the housing/hotel subsystem 114.

In an embodiment, the claims processing system 100 may include an accounting subsystem 116 to manage payments and invoicing for a claim 352. The accounting subsystem 116 may include an accounting user interface 126 used by an accounting coordinator 106. The accounting user interface 126 may enable the accounting coordinator 106 to assist in various accounting tasks. Although various tasks are described herein as being accomplished by the accounting coordinator 106 or the accounting subsystem 116, it is contemplated that any task carried out by the accounting coordinator 106 may, in other embodiments, be automatically carried out by the accounting subsystem 116.

In an embodiment, the claims processing system 100 may include a corporate claims subsystem 117 to permit users from the insurance company 107 to audit claims 352 processed by the claims processing system 100. The corporate claims subsystem 117 may include a corporate claim user interface 127, such as a web portal, to permit an insurance company user to perform a desired audit.

In an embodiment, the claims processing system 100 may include a claims database 131 to store data related to claims 35. In an embodiment, the claims processing system 100 may additionally include a hotel database 132 to store data related to hotels available for booking for insured persons 101. In an embodiment, the claims processing system 100 may additionally include a housing database 133 to store data related to housing available for rent for insured persons 101. Further, in an embodiment, the claims processing system 100 may include an accounting database 134 to record entries related to the payment of vendors 105, the billing of insurance companies, and other entries related to the processing of claims 352.

In an embodiment, any or all of the insured persons user interface 121, the CEM user interface 122, the adjuster user interface 123, the H/H user interface 124, the accounting user interface 126, and the corporate claim user interface 127 may be embodied in a collection of software windows of a claim processing application 130. The claim processing application 130 may be a software application (such as a Windows application) run on a local or remote (e.g., a remote desktop) user machine that communicates with remote server(s) of the remainder of the claims processing system 100. In other embodiments, any or all of the insured persons user interface 121, the CEM user interface 122, the adjuster user interface 123, the H/H user interface 124, the accounting user interface 126, and the corporate claim user interface 127 may be accessible using web-based portals of the claims processing system 100.

In an embodiment, the insured persons subsystem 111, customer experience subsystem 112, adjuster subsystem 113, hotel/housing subsystem 114, accounting subsystem 116, corporate claim subsystem 117 may be configured as various software modules stored in one or more memories 150 that may be executed on one or more controllers 140. The controllers 140 may be in communication with the claims database 131, the hotel database 132, the housing database 133, and the accounting database 134. For example, the insured persons subsystem 111, customer experience subsystem 112, adjuster subsystem 113, hotel/housing subsystem 114, accounting subsystem 116, corporate claim subsystem 117 may be software modules of the claim processing application 130 that are run on a local or remote user machine that communicate with the claims database 131, the hotel database 132, the housing database 133, and the accounting database 134.

In order to promote price transparency, in an embodiment, all leases for goods and services are between the insured persons 101 and the vendor 105 providing the goods and services. Additionally, in an embodiment, the adjuster 103 has 3 payment options: 1.) Pay the vendor 105 directly, 2.) Deposit funds on the Insured's Debit Card who then pays the vendor 105 directly or, or 3.) Deposit funds with under the control of the claims processing system 100 that then pays the vendor 105 directly.

The claims processing system 100 may leverage the combined claims volume of various insurers to negotiate discounts from the retail incurred cost of goods and services. In an embodiment, the discounts, rebates, and other savings from the vendor 105 (hereinafter, shared savings) may be shared between the adjuster 103 and the claims processing system 100. For example, the shared savings may be split in half between the insurance company 107 and the claims processing system 100. The shared savings may act as an incentive for the claim processing system 100 to be focused on decreasing Coverage D payouts and increasing value—and continually be motivated to prove that exceptional quality can actually cost less. Accordingly, the claims processing system 100 may include functionality to generate and track these shared savings.

In an embodiment, the shared savings may be tracked for each claim 352. For example, the claims processing system 100 may store the vendor 105 leases between insured and vendor 105 with all up-front discounts duly noted on the original quotes for goods and services. Additionally, the claim processing system 100 may store copies of front/back of all checks issued by the claims processing system 100 to a vendor 105 for costs of goods & services contracted to an insured.

In an embodiment, the claims processing system 100 may notify the adjuster 103 with an invoice for the shared savings. The invoice may include both the vendor 105 leases and the copies of the issued checks may be provided to the adjuster 103 via an adjuster subsystem to permit the auditing of the shared savings.

Insurance companies may audit each and every claim 352 at any time without notification by using a corporate claims portal. The corporate claims portal may include a copy of vendor leases, issued checks, and an audit of each claim 352.

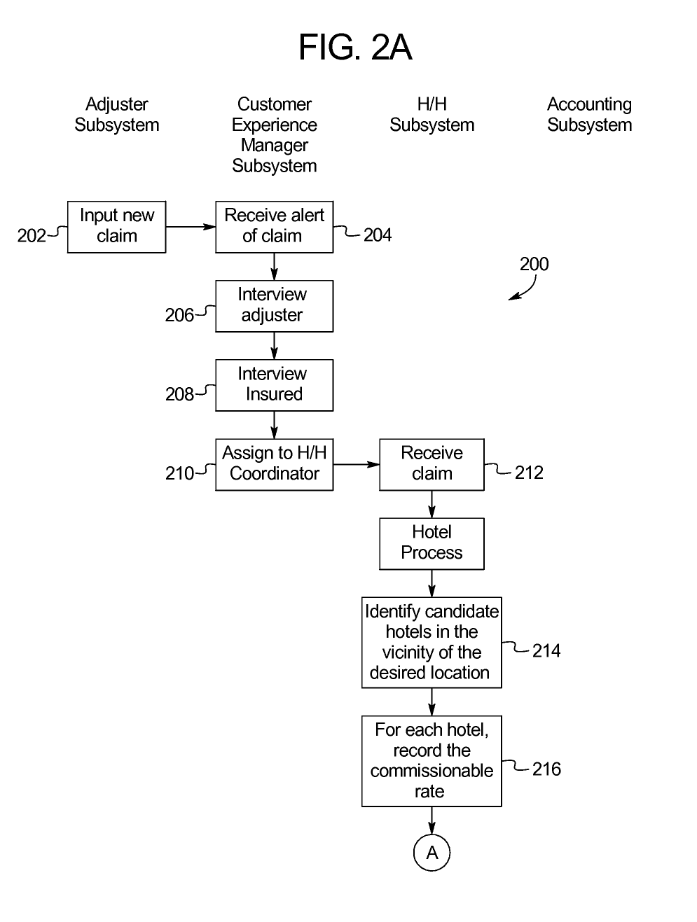

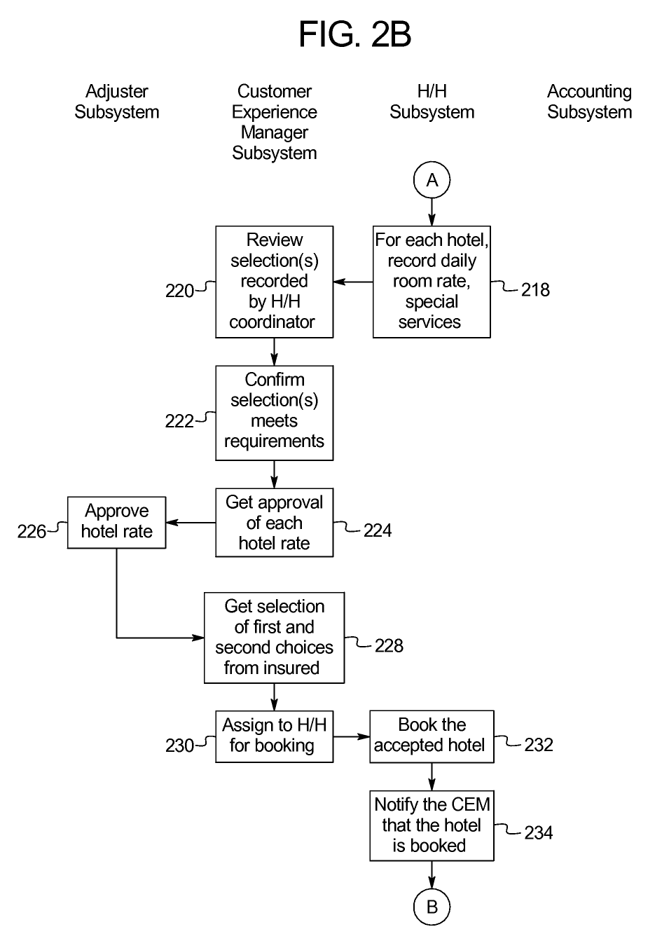

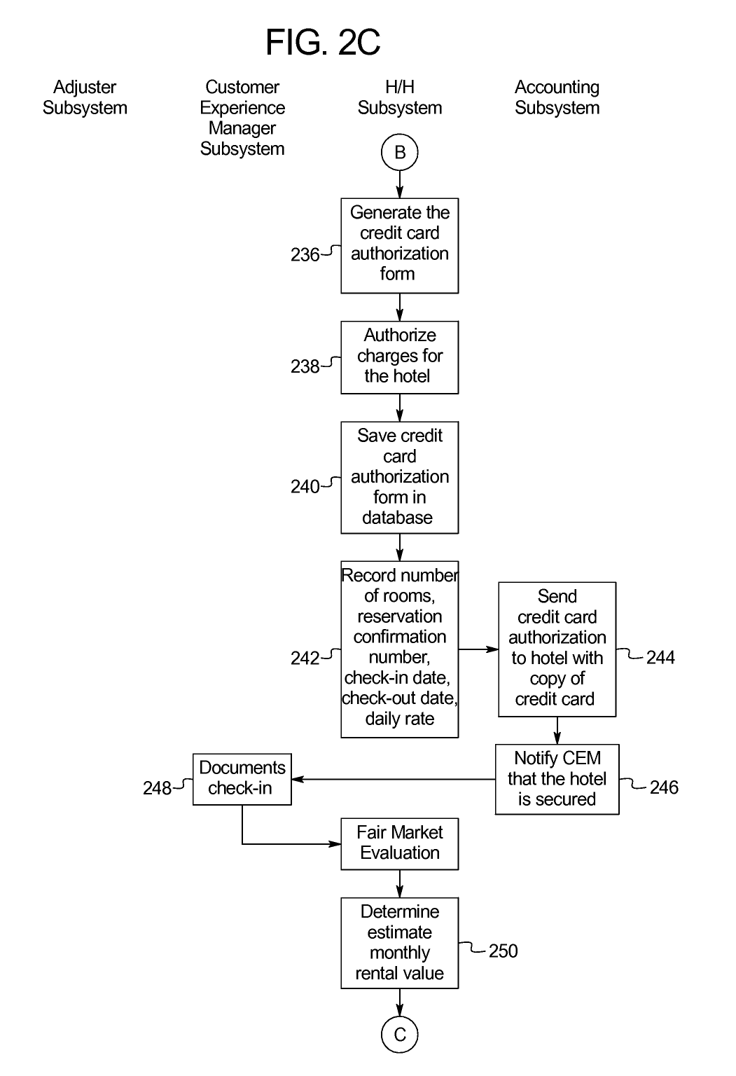

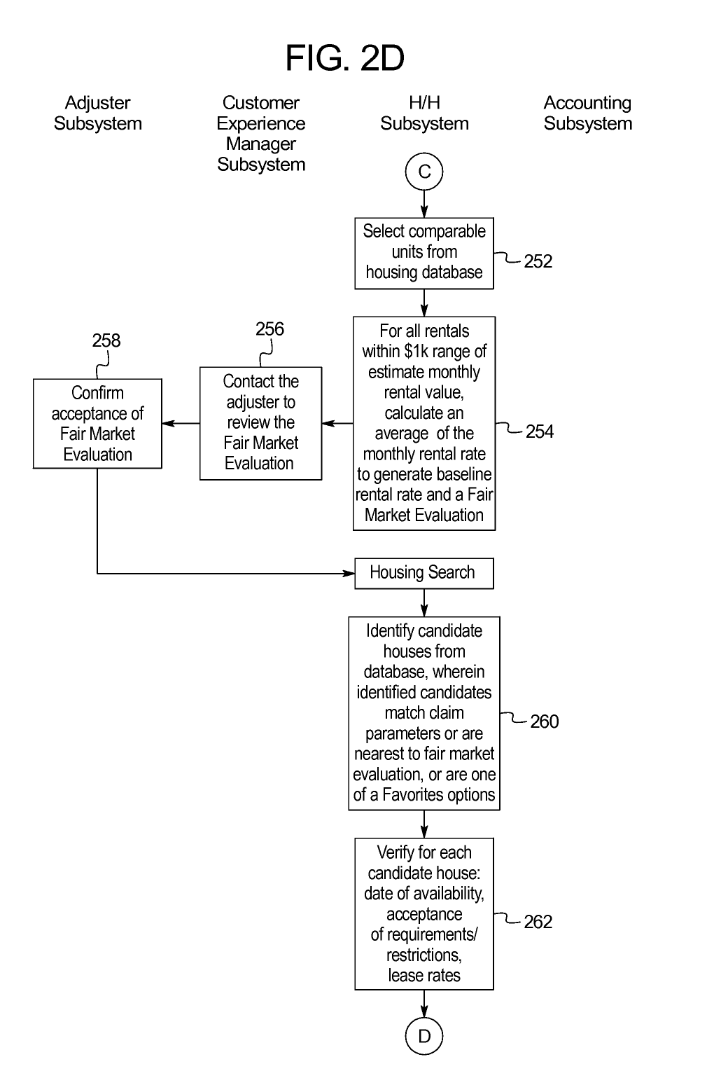

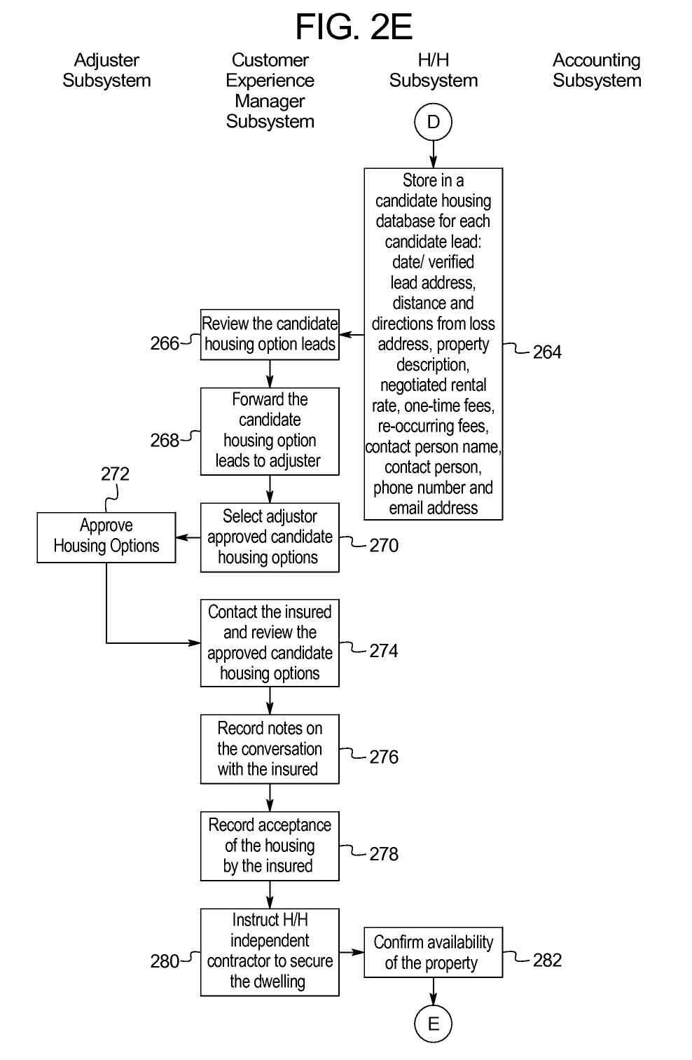

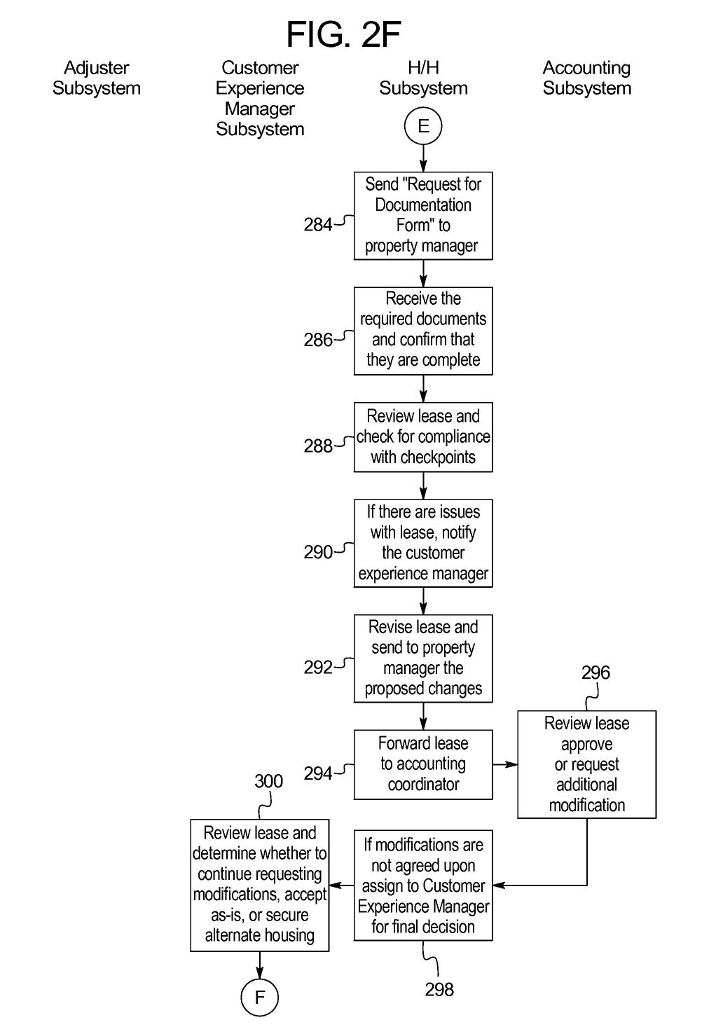

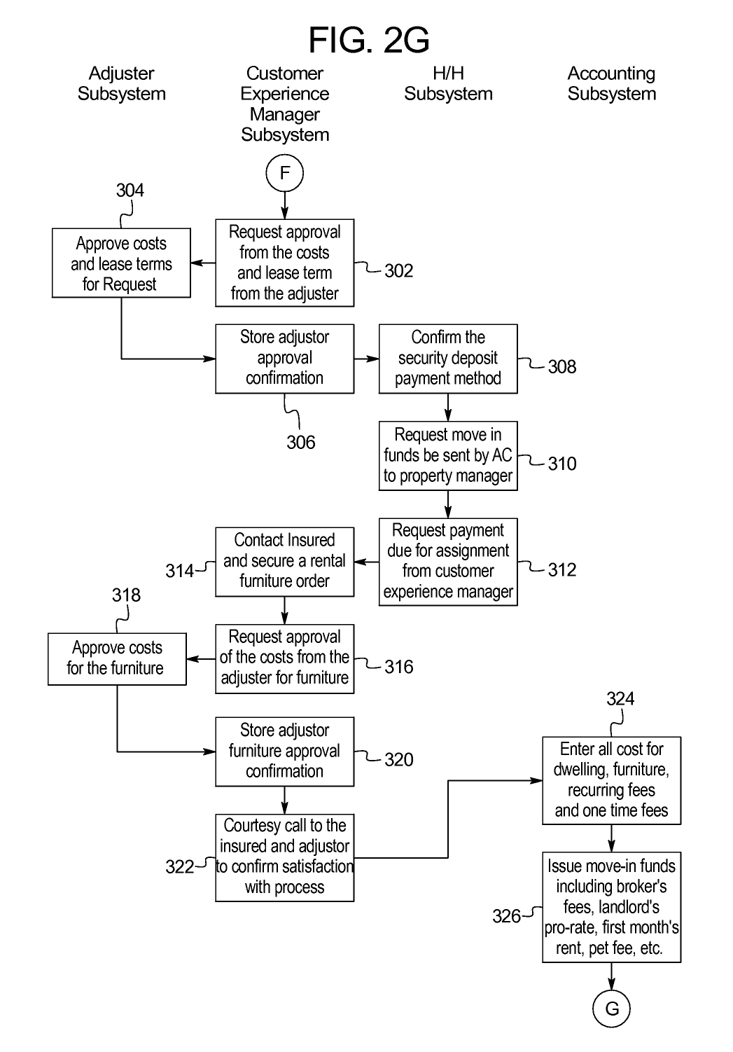

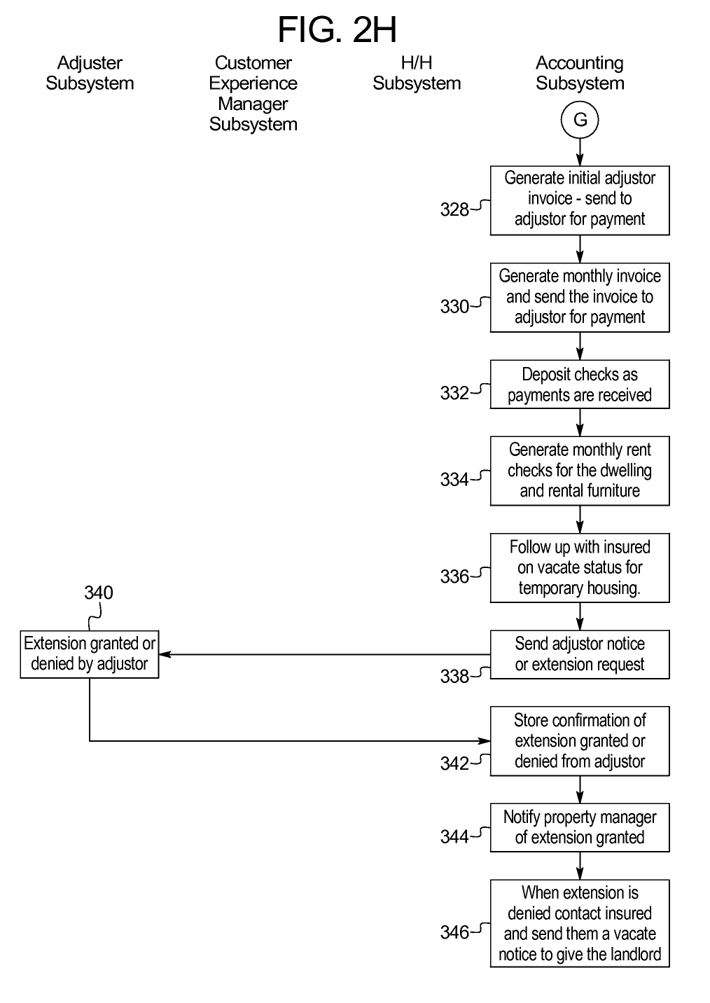

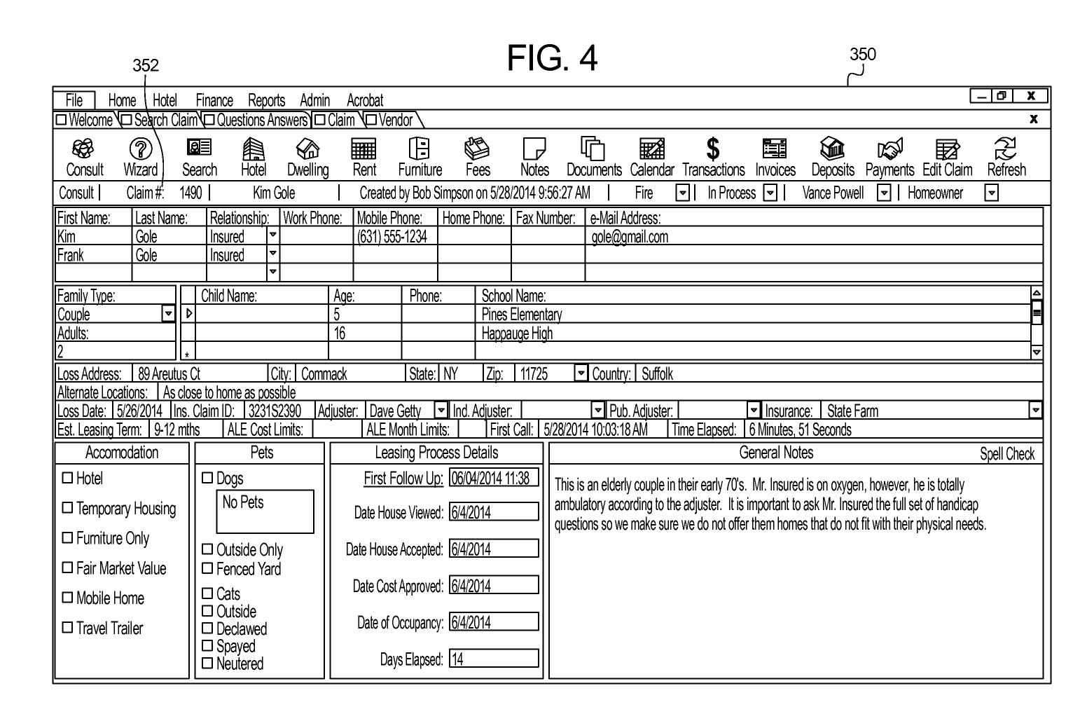

In an embodiment, the claims processing system 100 may carry out a claims processing method 200 to perform the functionality described herein. As shown in FIGS. 2A-2H, in an embodiment, a claim processing method begins at step 202 when the claims processing system 100 receives a new claim 352 (FIG. 4). The new claim 352 may be received by an adjuster subsystem 113 and stored in the claims database 131. For example, the adjuster 103 may access an adjuster user interface 123 to input the new claim 352. Once a new claim 352 is entered, the adjuster user interface 123 may notify the customer experience subsystem 112 to start processing. The CEM user interface 121 may then, in turn, notify the CEM 102 about the new claim 352.

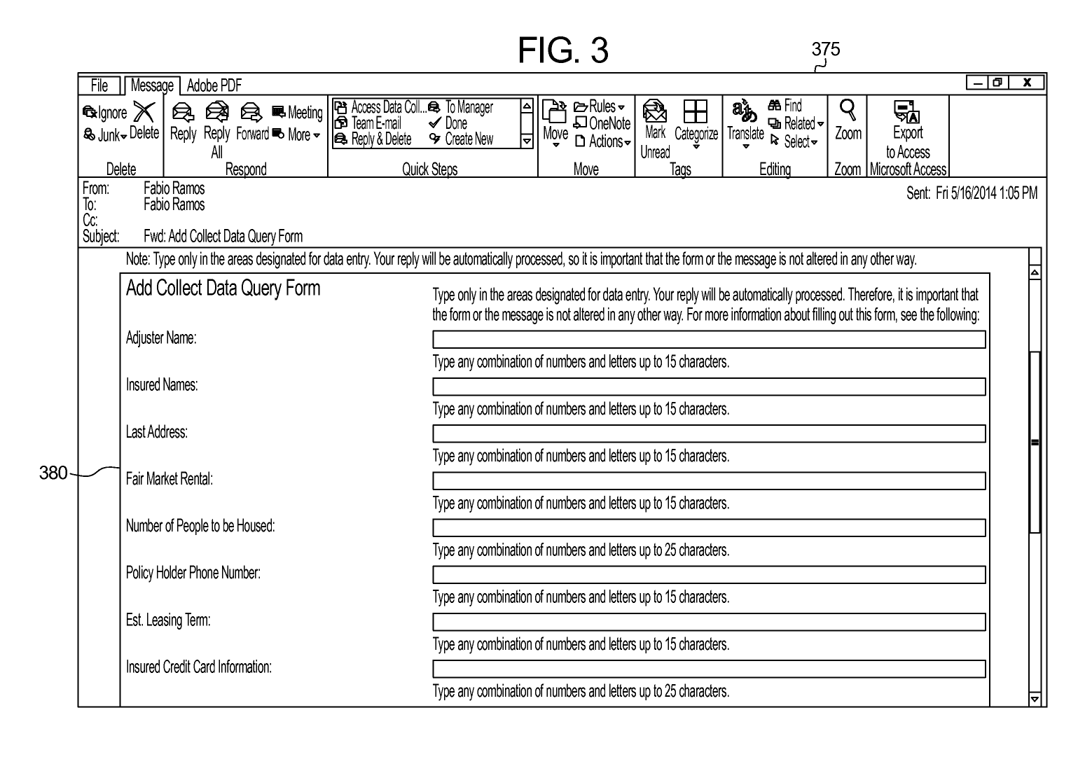

Alternatively, the CEM 102 may directly enter the new claim 352 into the CEM user interface 121 (for example, if the adjuster 103 calls in the claim 352 to the CEM 102). In another embodiment, shown in FIG. 3, the adjuster 103 may email the claim 352 using an email window 375 to the claim processing system 100 using an email form 380. The claim processing system 100 may then automatically parse the email and populate the claim 352 in the claims database 131.

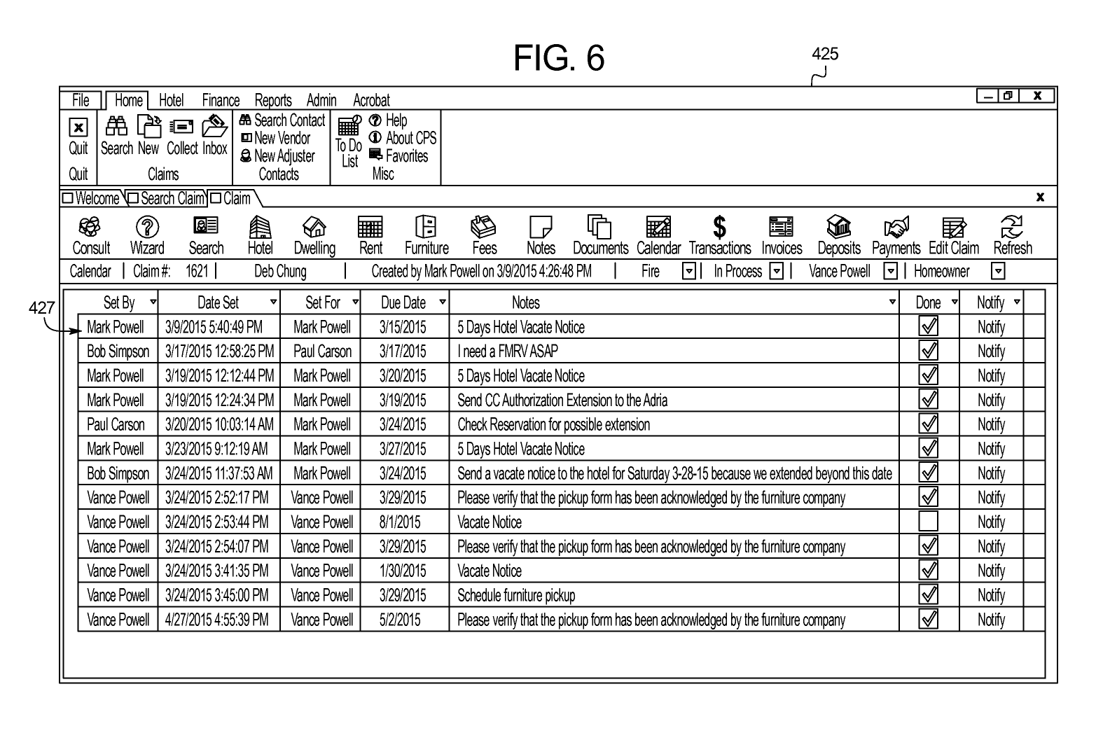

As shown in FIG. 4, the CEM user interface 121 may provide a consult screen 350 to permit the CEM 102 to review the claim 352. At step 204, the CEM 102 may receive a calendar alert 427 (FIG. 6) regarding the new claim 352 and use the consult screen 350 to confirm all the information is received. For example, the CEM 102 may contact the adjuster 103 to confirm the accuracy and spelling of sensitive information such as the insured's name, phone number, claim number, loss address including designations such as street, road, circle, etc., ALE limits, primary contact person, etc. If data is missing, the CEM 102 may directly enter the information (for example, by calling the adjuster 103 and getting the needed information) or notify the adjuster 103 via the adjuster subsystem of the missing information. The CEM 102 may also contact the adjuster 103 or the insured persons 101 and ask whether the temporary housing may be located slightly outside the area of the loss. If insured persons 101 say yes, a record of alternate locations may be entered in the consult screen 350 and any specific information about these locations may be entered in the General Notes section on the consult screen 350. Finally, the CEM 102 may record the school or daycare needs of any children, if applicable.

In an embodiment, shown in FIG. 4, the consult screen 350 includes: biographical information of the insured persons 101; pets information; loss information; policy information; accommodation needs; a leasing processing details box; general notes; etc. Biographical information may include the first name, last name, insurance relationship (insured, not insured), work phone, mobile phone, fax number, email address, family type, number of adults, name of each child, age of each child, phone number of each child, and school for each child. The pets information may include the number of dogs, cats or other pets, whether the pets are declawed, spayed, and neutered, and whether the pets are outside only and/or must have a fenced yard. The loss information may include the loss address, city, state, zip code, county, and loss date. The policy information may include the insurance claim ID, the adjuster name, independent adjuster, public adjuster, insurer name, ALE dollar limits, and ALE month limits. Accommodation needs may include claim parameters used to identify or automatically select acceptable housing accommodations, for example, accommodation needs may include desired alternate locations, estimated leasing terms, and whether there is a need for: a hotel, temporary housing, furniture, a fair market value estimate, a mobile home, and/or a travel trailer. Leasing Process details may include the time of a first call, a first follow up, a date the housing option(s) were viewed, a date a housing option was accepted, a date the cost of housing was approved, a date of occupancy, and a time from first call to occupancy.

Once the claim 352 is correctly populated in the claims database 131, the adjuster 103 may receive an auto response acknowledging the receipt of the claim 352 from the adjuster subsystem. The adjuster subsystem may then notify the adjuster 103 of the receipt of the claim 352. Alternatively, if the claim 352 is missing information, the adjuster subsystem may determine that the information is missing, or may be notified of the missing information by the customer experience subsystem 112. The adjuster subsystem may then notify the adjuster 103 of the missing information.

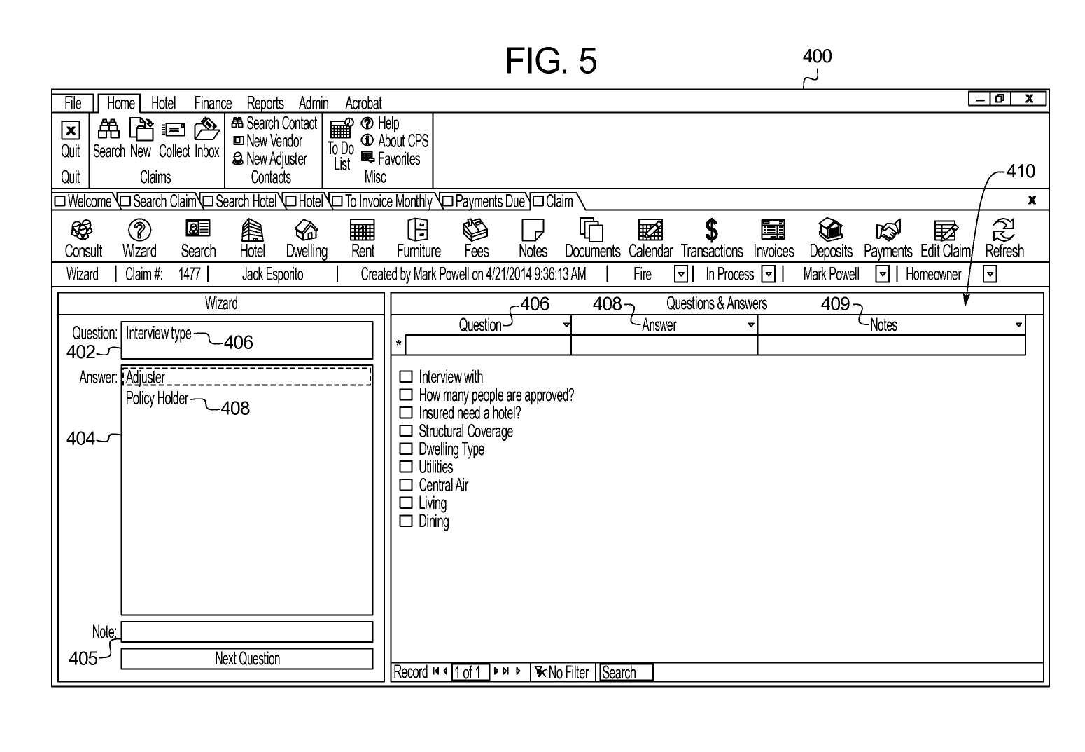

Next, if the insured party needs a hotel reservation, the customer experience subsystem 112 may collect information on the hotel needs of the insured persons 101. For example, in an embodiment, at step 206, the CEM 102 may access a wizard screen 400, as shown in FIG. 5. The wizard screen 400 may include a question prompt 402, an answer selection box 404, and a notes box 405. The CEM 102 may select the answer 408 for each question 406, enter notes 409 as needed, and hit next question 406 to move on to the next question 406. A question & answer list box 410 may list the questions 406, answers 408 received, and any notes 409.

In an embodiment, the CEM 102 may interview the adjuster 103 and record the answers 408 to the following questions 406: Do you have a hotel you want us to use? Do you prefer a hotel with a kitchenette or full kitchen if it is an option near the loss address? How many rooms are you approving? Are you approving room & tax only or guest services such as pet fee, parking, food, internet, phone etc. What are the Check-in-date and the Check-out-Dates? If the hotel stay is thirty to forty-five days, does the adjuster 103 prefer: a) a hotel with kitchen facilities if available in the loss area, or b) a fully furnished apartment? If the hotel stay is forty-five to sixty days does the adjuster 103 prefer: a) a hotel with kitchen facilities if available in the loss area, or a Fully Furnished apartment for a lease period of 90 days. (Refer to Extended Hotel Stay Protocol). The CEM 102 may record the answers to the questions 406 and then proceed to interview the insured persons 101 or assign the claim 352 to the hotel/housing subsystem for further processing. The answers to each of these questions 406 may be used as claim parameters by the H/H subsystem when identifying or selecting hotel accommodations and temporary housing. It is believed that various combinations or sub-combinations of these search parameters may be used to provide unique embodiments of the claims processing system 100.

In an embodiment, the CEM user interface 121 may include a wizard screen 400 to enable the CEM 102, at step 208, to interview and collect information about the claim parameters such as the temporary housing needs of the insured persons 101. The interview screen may prompt the CEM 102 with questions 406 and receive input of answers 408. The answers provided may be stored in association with the claim 352 in the claims database 131. In an embodiment, questions 406 may include: Which family member is the primary decision maker? Does anyone in the family have any special needs? Was any member of the family injured or killed in the loss? Is any member of the family elderly or mobility restricted? Are there pets? Was a pet injured or killed in the loss? What type of dwelling was the loss (detached single house, semi-detached house, legal two or three Family House, etc.) If there was greater than 5 adult occupants in the loss, are two dwellings equaling the fair market of the loss an option (duplex, condo, etc.)? What was the style of the dwelling (Ranch, Colonial, Two story, Mobile Home, etc.)? How many total rooms? Was there a(n): office? bonus room? living room? dining room? family room/den? How many total bedrooms? How many total baths and Half Baths? Was the basement finished/unfinished? Did the basement have a bathroom? Was there a garage? Was there a carport? Was there out buildings on the property? Was there a swimming pool? If so, was the swimming pool above ground or in-ground? Was there a fenced yard? Is there anything specific to this family's needs or your needs that we have not discussed? The answers to each of these questions 406 may be used as claim parameters by the H/H subsystem when identifying or selecting hotel accommodations and temporary housing. It is believed that various combinations or sub-combinations of these search parameters may be used to provide unique embodiments of the claims processing system 100.

In an embodiment, the wizard screen 400 may additionally enable the CEM 102 to collect information about claim parameters such as the hotel needs of the insured persons 101. The information collected may include: the hotel check-in date; a hotel preference or a specific hotel the insured persons 101 prefer; a desired address where the insured persons 101 want the hotel to be located near (for example, close to the loss address or close to another address such as a work address); any alternate addresses and or major roads they need to be able to access easily from the hotel; the acceptable distance from the desired address in which the hotel should be located; whether any of the insured persons 101 use public transportation to school or work; the number of pets, and the species, name, breed, weight, spayed/neutered status, kennel needs, needs for fenced yard, normal amount of human presence, and special needs of the pets; whether the insured persons 101 want to bring the pets to the hotel, board the pet, etc.; whether the insured persons 101 need adjoining rooms if more than one room is booked; whether the insured persons 101 have any mobility restrictions, and, is so, the type of mobility restrictions, whether the persons can maneuver stairs, whether they use a walker, whether they use a wheel chair, the dimensions of the wheelchair, the need for a modified bathroom, the need for a hospital bed, and the need for a ramp; the need for a kitchen or kitchenette; the desire for a hotel with onsite restaurant; whether any of the insured persons 101 smoke. The answers to each of these questions 406 may be used as claim parameters by the H/H subsystem when identifying or selecting hotel accommodations and temporary housing. It is believed that various combinations or sub-combinations of these search parameters may be used to provide unique embodiments of the claims processing system 100.

In an embodiment, the CEM user interface 121 may include prompts to track interactions with the insured persons 101 to ensure timely completion of tasks. For example, the consult screen 350 of FIG. 4 may include a “First Call” button that the CEM 102 may press to record the time of the first call with the insured persons 101. Upon pressing the First Call button, the claims processing system 100 may record the time of the call in association with the claim 352 in the claims database 131.

As noted, the CEM 102 may manage the hotel booking process carried out by the housing and hotel subsystem. For example, at step 210, the CEM 102 may assign the claim 352 to a H/H coordinator 104 using an assignment field in the claim screen. Then, using a calendar screen of the claims processing system 100, the CEM 102 may set a calendar alert for the H/H coordinator 104 to locate a hotel. The CEM 102 may additionally use the claims processing system 100 to communicate a message to the H/H coordinator 104 requesting hotel options. Alternatively, the customer experience subsystem 112 may communicate to hotel/housing subsystem to request hotel options.

Turning to FIG. 6, a calendar screen 425 allows a user to see and create calendar alerts 427. The calendar is used for delegating tasks to the CEM 102, the H/H Independent Contractor, the accounting coordinator 106 and other users of the claims processing system 100 who are involved in the claims process. Each calendar alert may include: a set-by user who created the calendar alert; a set date reflecting when the calendar alert was made; a set date for user who is to respond to the calendar alert; a due date; a calendar note explaining a task assigned; a done checkbox to indicate that the task is completed; a notification button that, when clicked, notifies the set for user that a calendar alert has been set; and a notification time, if any. All calendar alerts may be stored in the user's To Do List and are made read-only.

The housing/hotel subsystem (H/H subsystem) may begin processing a claim 352 at step 212 when it receives a claim 352 including a desired location for the insured persons 101. First, at step 214, the H/H subsystem may identify candidate hotels in the vicinity of the desired location matching within a range for each of the claim parameters provided in the interviews with the adjustor and the insured persons 101. For example, in an embodiment, the H/H coordinator 104 may use access a hotel database 132 of the claims processing system 100 via the H/H user interface to search for hotels near the loss address.

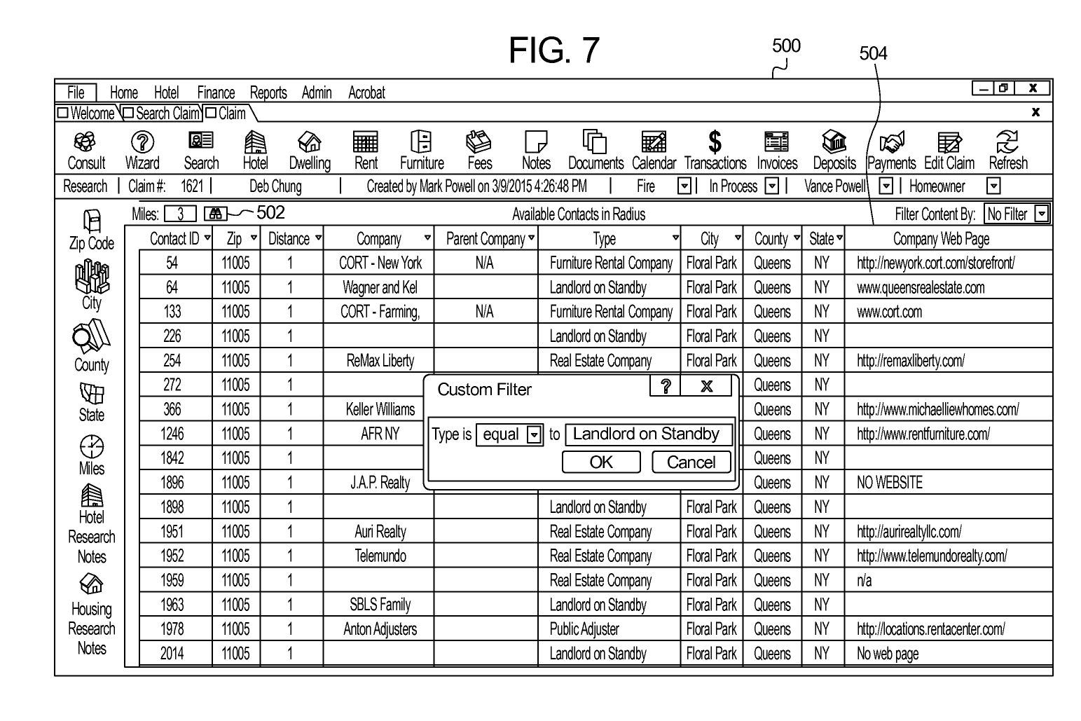

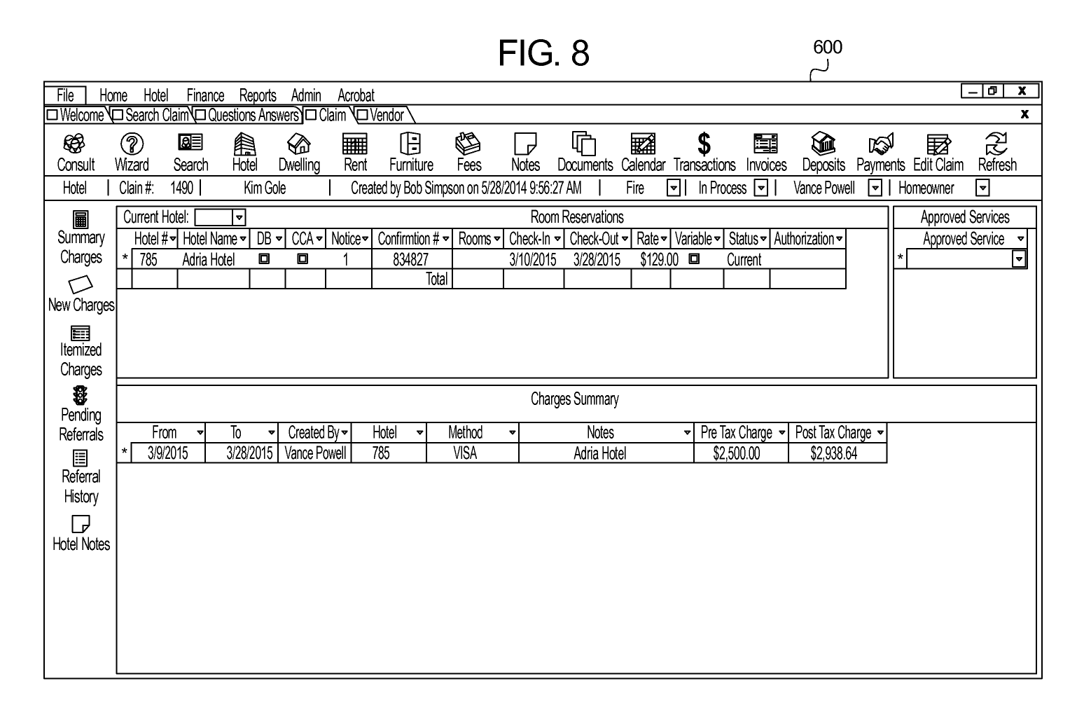

As shown in FIG. 7, a H/H coordinator 104 may access a research screen 500 to research hotels and housing. FIG. 7 illustrates searching in the housing database 133, however, the research screen 500 for searching the hotel database 132 may be include equivalent functionality. A distance box 502 may be used to enter a maximum distance to limit the results to those within the maximum distance from the loss address.

When searching hotels, the H/H coordinator 104 may use any of the claim parameters, such as housing needs, hotel needs, etc., to identify candidate hotels. As shown in FIG. 7, the H/H coordinator 104 may apply filters to the database, where a filter may equal, expressly not equal, begin with, expressly not begin with, contain, ends, or expressly does not end with the filter input. In some embodiments, the H/H subsystem may apply filters auto-generated from the claim parameters to identify candidate hotels.

Alternatively, the H/H coordinator 104 may search a public web database for hotels near the loss address. For each housing option found using public databases, the H/H coordinator 104 may add the details of the housing option to the housing database 133.

For each hotel, at step 216, the H/H subsystem may determine a commissionable rate and record the rate in the claims database 131 in association with the claim 352. Likewise, at step 218, the H/H subsystem may determine the daily room rate, and any special services and record both in the claims database 131 in association with the claim 352. For example, the commissionable rate, daily room rate, and special services may be automatically looked up in a hotel database 132 of the claims processing system 100 or retrieved from an external database. Alternatively, the H/H coordinator 104 may obtain the commissionable rate, daily room rate, and special services by calling the hotel.

Upon the customer experience subsystem 112 receiving the hotel selections from the H/H subsystem, at step 220, the customer experience subsystem 112 may review the hotel selections. For example, the CEM user interface 121 may include a hotel search notes screen to permit the CEM 102 to review the hotel selections.

In an embodiment, a reservations screen 600 may display hotel information from the hotel database 132. The reservations screen 600 may include a selection box to select between viewing the suggested hotels for a claim 352 and viewing the selected hotel for the claim 352. A listing of hotels box may display the suggested hotels or selected hotels. For each hotel, the listing of hotels may include the hotel number, the hotel name, a radio button to indicate that a direct billing agreement in place, a radio button to indicate whether the hotel has a credit card authorization form in place, a notice field indicating the number of days required to provide an early vacate notice, the number of rooms, a confirmation number, the check-in and check-out dates, the daily rate, and a combo box displaying a selection of approved services. In some embodiments, the listing of hotels may additionally include a discounted rate for the shared savings calculation.

At step 222, the CEM 102 may then confirm that the selections meet the criteria provided by the insured persons 101. Additionally, at step 224, the CEM 102 may contact the adjuster 103 to get approval on the hotel rate. Alternatively, the adjuster user interface 121 may provide the adjuster 103 the hotel rate and the corresponding hotel rate documents and receive an approval from the adjuster 103. Upon receiving the adjuster 103 approval at step 226, the CEM 102, at step 228, may contact the insured persons 101 to go over all the hotel selections and inform the insured persons 101 of details such as the name of the hotel address, the guest services available at each hotel such as breakfast buffet included in the room rate, free laundry facilities available to guests, etc. The CEM 102 may then record the insured persons 101 first choice and second choice (if applicable) of hotels. At step 230, the CEM 102 may then assign the claim 352 back to the H/H Coordinator 104 to have the hotel booked.

Once the hotels are presented to the insured and a desired hotel is received, at step 232, the H/H subsystem then books the accepted hotel. For example, the H/H coordinator 104 may receive the notification from the CEM 102 on his or her To Do screen to book the hotel. The H/H coordinator 104 may then call the hotel to book the desired room, or book the room online. Alternatively, the H/H subsystem may automatically book the hotel room via an electronic booking system. Once the hotel is booked, at step 234, the H/H coordinator 104 may notify the CEM 102 that the hotel is booked.

Upon receiving notification that a hotel has been booked, the CEM 102 may contact the insured persons 101 with the name of the hotel, the phone number and the address of the hotel along with the reservation number(s). After the insured persons 101 have checked in, the CEM 102 may confirm the check-in in the claims processing system 100. The CEM 102 or the adjuster subsystem may then notify the adjuster 103 that the insured persons 101 are checked-in to a hotel.

For example, at step 238, the H/H subsystem or the H/H coordinator 104 may generate a credit card authorization for that hotel, and authorize charges for that hotel. At step 240, the credit card authorization may be stored in the accounting database 134 in association with the claim 352 along with, at step 242, a record of the number of rooms, a reservation confirmation number, check-in information, check-out dates, and a daily rate. At step 244, the accounting coordinator 106 may then send the credit card authorization to the hotel with a copy of the credit card or other payment information. Once completed, at step 246, the accounting coordinator 106 may notify the CEM 102 that the hotel is secured.

The notification may include the hotel confirmation number. The CEM 102 or the accounting coordinator 106 may save the hotel confirmation number and documents associated with the hotel check-in in the claims database 131 in association with the claim 352.

Next, the claim processing system 100 may locate temporary housing for the insured persons 101. This may begin, for example when the CEM 102 uses a calendar screen to set a calendar for the H/H coordinator 104 to begin the process of locating temporary housing options using the information associated with the claim 352. Alternatively, the customer experience subsystem 112 may automatically notify the H/H subsystem to begin the temporary housing process upon receiving confirmation of the hotel reservation. Either way, the notification may include a deadline and/or a read receipt alert.

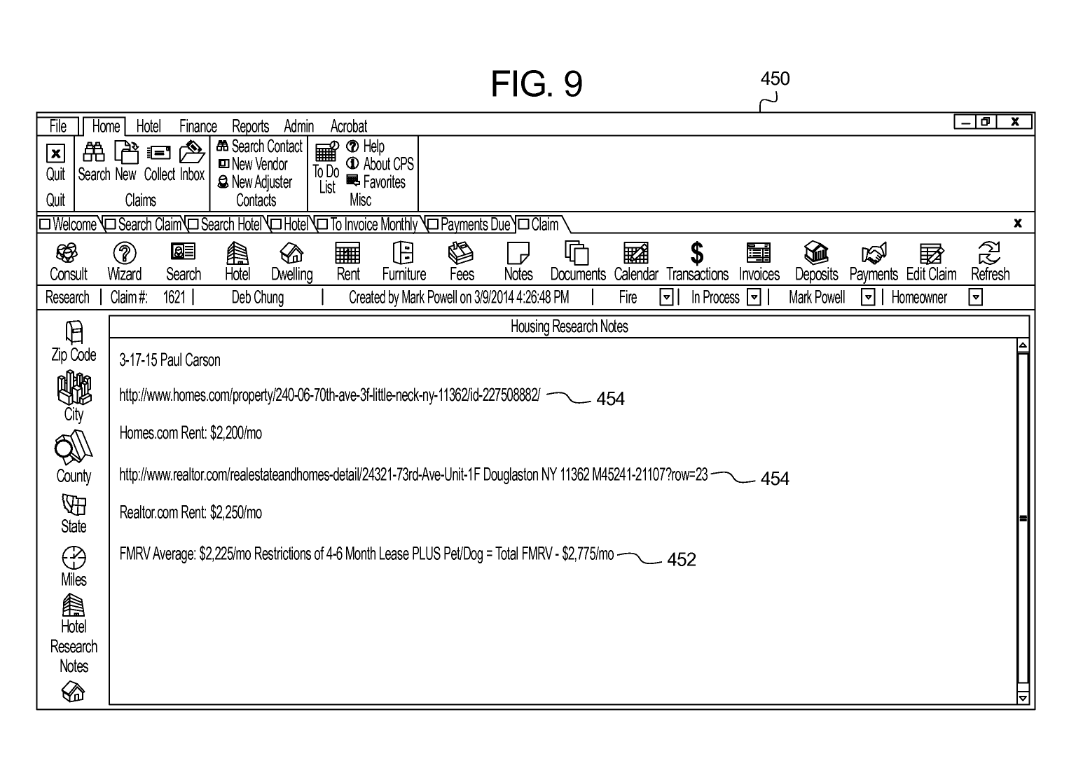

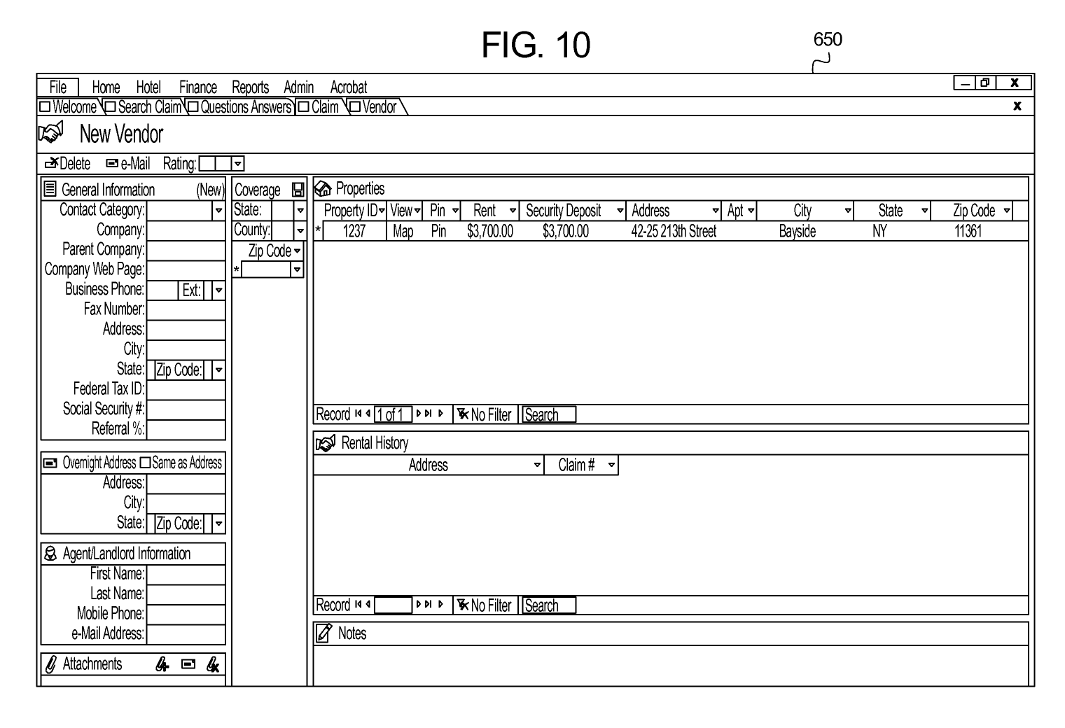

As shown in FIG. 9, in a housing notes research screen 450 to begin the temporary housing search, at step the H/H subsystem determines a fair market evaluation 452 of the loss. To determine the fair market evaluation 452, first, at step 250, the H/H subsystem makes a rough estimate of the loss by determining an estimated monthly rental value. The rough estimate may be provided to the system by the H/H contractor, or determined from basic information regarding the loss, such as the type of dwelling, the number of bedrooms and bathrooms, the location of the loss, etc. Next, step 252, the H/H subsystem selects from a housing database 133 of nearby rentals those comparable units 444 that have the same type of dwelling, the same number of bedrooms, and the bathrooms. If there is no matches, or a number less than a predetermined amount, the H/H subsystem may back off the criteria until a predetermined number of rentals are selected. For example, the H/H subsystem may first drop the bathroom criteria, then drop the bedroom criteria, and then expand the location criteria until the predetermined number is reached. In an embodiment, the predetermined number is one to ensure a result. In other embodiments, the predetermined number is two to minimize the effect of outliers. In yet a further embodiment, the predetermined number is three to further minimize the effect of outliers. For all rentals selected, at step 254, the H/H subsystem may exclude those rentals not within one thousand dollars of the rough estimate, and average the monthly rental rate of the remaining selected rentals with the result being the fair market evaluation 452.

The H/H coordinator 104 may then notify the CEM 102 of fair market evaluation 452 of the baseline rental rate. Upon receiving the fair market evaluation 452, at step 256, the CEM 102 or the adjuster subsystem may notify the adjuster 103 of the fair market evaluation 452 and, at step 258, receive the adjuster's approval or denial of the fair market evaluation 452. The CEM 102 may then notify the H/H coordinator 104 of the adjuster's approval or denial. If the fair market evaluation 452 is denied, the H/H coordinator 104 may adjust the fair market evaluation 452 to correct for any issues noted in the denial.

At step 260, the H/H subsystem may then select housing options from the database. In an embodiment, the H/H contractor may access a housing screen to search the housing database 133 using the claim parameters, or the H/H contractor may also choose housing options from the list of Favorites. Favorites may include vendors 105 that have agreed to provide discounted rates. Returning to FIG. 7, a H/H coordinator 104 may access a research screen 500 to research housing options. A distance box 502 may be used to enter a maximum distance to limit the results to those within the maximum distance from the loss address. For each result in a list of results 504, the research screen 500 may include details, such as the contact ID, zip code, distance from loss, vendor name, vendor type, vendor city, vendor county, vendor state, vendor web page, etc.

A vendor screen may be provided to view vendor information in the housing database 133 and research available housing options. For example, a vendor 105 may be selected from the Favorites to access the vendor screen. The vendor 105 screen may include general information on the property, an overnight address, agent/landlord information, a listing of areas the vendor 105 has properties, document attachments associated with the vendor 105, a list of rental property available, a rental history with the vendor 105, and text notes. General information may include the contact category (apartment complex, apartment finding service, contractor, corporate furnished apartment providers, furniture rental company, insurance company, Kennels, landlord on standby, mobile homes provider, property management, real estate company, rehab/nursing home, etc.), a company name, a parent company name, a company web page, a business phone number, a fax number, a company address, city, state and zip code, a federal tax ID, a social security number, a referral percentage or discount percentage, and any referral notes. The agent/landlord information may include the agent name, agent mobile number, and agent address. The listing of areas the vendor 105 has properties box may permit a user to enter a state, county, city, and zip code and then press a save button to add a coverage area to the listing of areas. The list of rental properties available may include fields such as an address field, an apt number field, a city field, a state field, a zip code field, a property type field, a map button to launch a web based map showing the property, and a pin button to add a property to the list of housing options in the currently open claim 352. In an embodiment, if the H/H coordinator 104 presses the pin button, the rental property may be added to the dwelling screen as a housing option.

The information in the vendor screen may be limited so that only H/H contractors may write to it. Because H/H contractors are independent contractors and not employees, this helps the claims processing system 100 guarantee that the quoted prices for a housing option are not marked-up by other users, such as the CEM 102 or the accounting coordinator 106.

For each candidate housing option, at step 262, the H/H subsystem or H/H contractor may verify the date of availability, acceptance of requirements/restrictions, and the lease rates. The H/H subsystem or H/H contractor may then, at step 264, store in housing options in association with the claim 352, each housing option including: the date of availability, the housing option address, distance and direction from loss address, the property description, the negotiated rental rate, any one-time fees, re-occurring fees, contact person name, contact person phone number, and contact person email address.

Next, at step 266, the CEM 102 may review the housing options and confirm the selections meet the requirements provided by the insured.

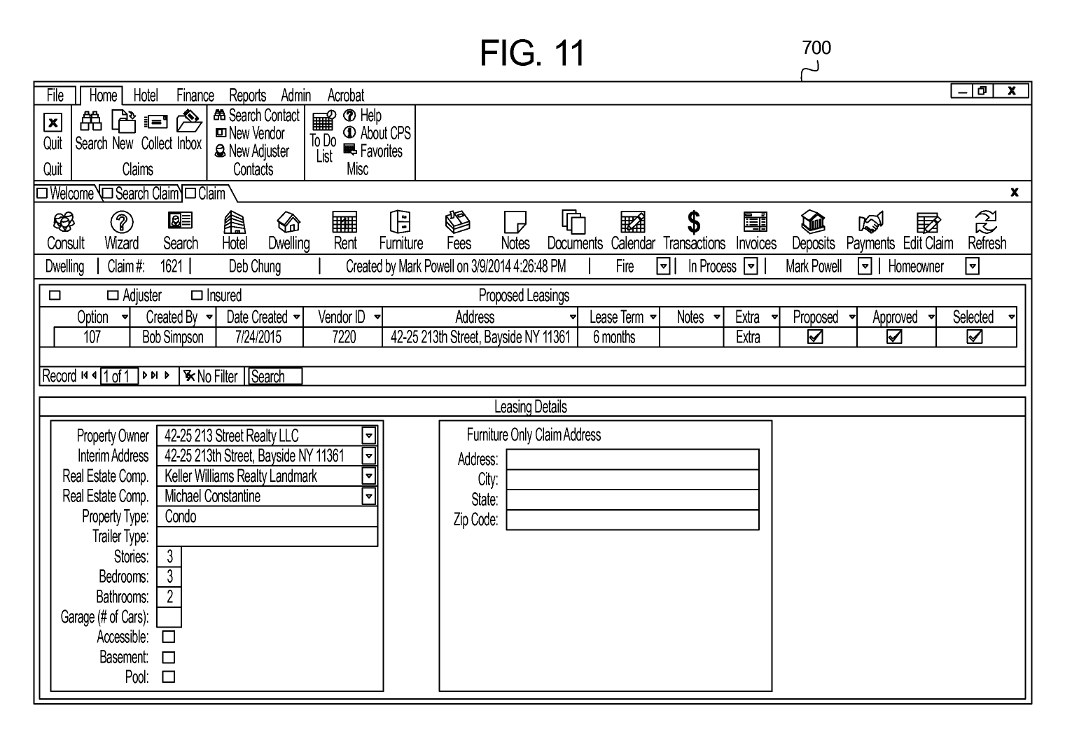

In an embodiment, shown in FIG. 11, a dwelling screen 700 may display the housing options under consideration or accepted for a claim 352. The dwelling screen may include a housing options list that may be filterable and sortable based on the data for each housing option. For a selected housing option of the housing options list, the dwelling screen may include leasing details. For each housing option, the housing options list may include an automatically generated option number, the user who created the option, the date the option was created, the vendor ID number, the location of the housing option, the lease term (in months), an extra services button to access a list of extra services for the proposed lease, notes, a proposed checkbox to indicate that the adjuster 103 has been notified of the housing option, an approved checkbox indicating that the housing option has been approved by the adjuster 103, etc. The leasing details may include a property owner, an interim address drop box to show one or more rental properties for the vendor 105, the real estate agent of record for the claim processing system 100, the property owner's real estate agent, the property type, the trailer type (if applicable), the number of stories, the number of bedrooms. The CEM 102 may click on the adjuster button or an insured button to send the housing options to the adjuster 103 or the insured.

At step 268, the adjuster subsystem 113 or the CEM 102 may then notify the adjuster 103 of each of the housing options along with housing details for each option. For Example, the housing details may include: Monthly Rental Amount; Lease Term; Broker Fee; Pet Fee; Window Blinds; Window Unit Air Conditioners; Snow Removal Fee; Lawn Care Fee; Parking Garage Fee; Property Address; type of Housing (single family, semi-detached, condo, apt, mobile home, etc.); delivery/set-up costs for mobile homes; the school district; etc. Upon the adjuster 103 approving the housing options in step 272, the CEM 102 enters the time that the approval of costs for the housing options was approved by the adjuster 103 in the leasing processing details box on the consult screen 350.

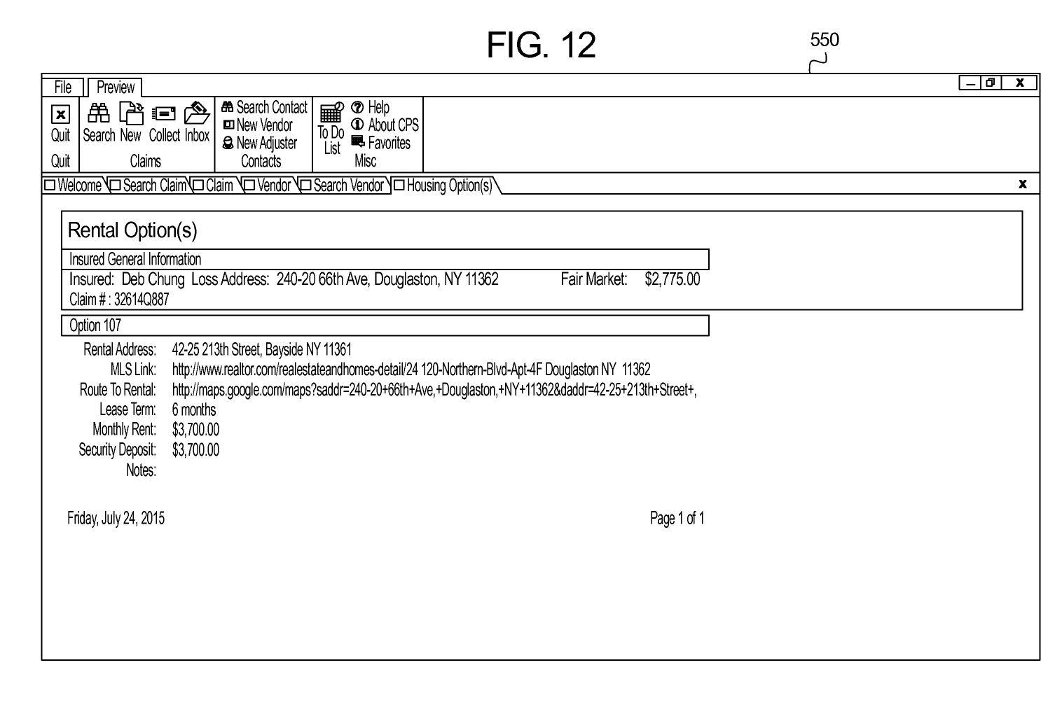

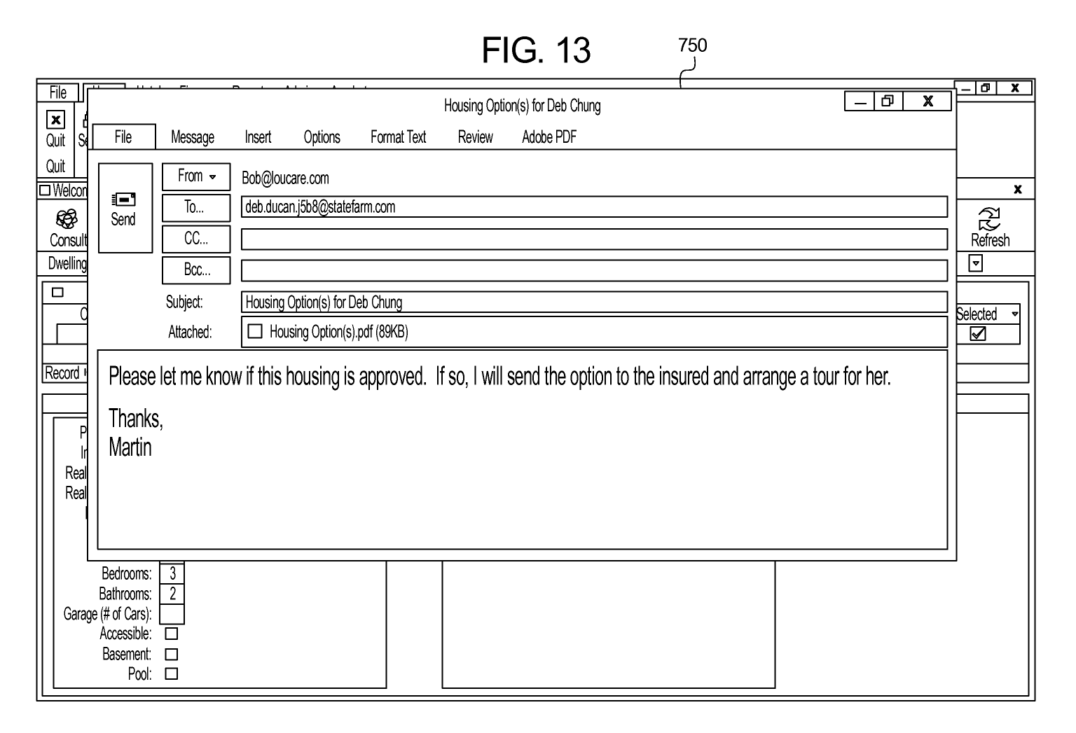

FIG. 12 illustrates a housing options screen 550 illustrating a housing option file that may be sent to an adjuster 103 as a pdf file. As shown in FIG. 13, in the housing options email screen 750, the housing option file may be included in an email to the adjuster 103 or the insured. In some embodiments, the housing options may be provided to the adjuster 103 and the insured via an adjuster user interface 121 or an insured persons user interface 121.

At step 274, the CEM 102 may then notify the insured persons 101 of the housing options. During the conversation, at step 276, the CEM 102 may record notes on the insured persons preferences. The CEM 102 may notify the insured persons 101 of the features and amenities of each housing option, such as: type (Detached Single Home, Semi-Detached Home, Condo, Duplex, Apartment, Mobile Home, Travel Trailer); concierge service; address of the property and the distance from the loss address; school district; number of bedrooms; number of bathrooms; the presence of an office; the presence of a den; the presence of an exercise room; the presence of a pool; the presence of a garage; available driveway parking or street parking only; the location and distance of accessible public transportation; pet conditions; the presence of a fenced yard; etc.

Afterward, the CEM 102 may make note of the conversation as the first-follow up in the lease process details box. In an embodiment, the first-follow up field may be auto-populated when the CEM 102 clicks on the field. The customer experience subsystem 112 may then schedule a conference call between the individual agents for each housing option and the insured persons 101 to schedule an appointment to view each property. The CEM 102 may enter the first appointment into the Date House Viewed field in the leasing process details box on the consult screen 350. Then, the customer experience subsystem 112 may record a status report from the individual agents regarding the tours. These steps may be repeated until the insured persons 101 choose a housing option.

Once the insured persons 101 choose a housing option, at step 278, the CEM 102 may record the chosen housing option and enter the date the insured persons 101 accepted the housing into the leasing process details box on the consult screen 350. Additionally, the lease of the chosen housing may be stored in the claims database 131 in association with the claim 352. The adjuster subsystem or the CEM 102 may contact the adjuster 103 for his or her approval of the costs and lease terms for the temporary housing. The customer experience subsystem 112 may additionally forward the lease to the accounting subsystem 116. For example, the CEM 102 may set a calendar task to have the accounting coordinator 106 issue checks.

At step 280, the CEM 102 may additionally set a calendar task to have the H/H coordinator 104 secure the dwelling for the insured, and to request checks from the accounting coordinator 106. The customer experience subsystem 112 may check the lease for compliance with policies of the adjuster 103 and the claims processing system 100. For example, the CEM 102 may upload a copy of the lease into the claims processing system 100 and input data regarding the compliance of the lease with the appropriate policies. Once the H/H coordinator 104 has secured the chosen housing, the CEM 102 may notify the insured persons 101 of the move-in date and any move-in instructions provided by the H/H coordinator 104. The CEM 102 may enter the date of occupancy into the leasing process details box on the consult screen 350. The consumer experience subsystem may, in turn, calculate the total number of days from the first call until the insured occupies the temporary housing, and this figure may be provided to the adjuster 103 via the adjuster user interface 121.

At step 282, the H/H subsystem may notify the property manager that the insured has decided to rent the chosen housing option and request that the property manager confirm availability of the chosen housing option. At step 284, the H/H subsystem may also provide the property manager with a “Request for Documentation Form.” At step 286, the H/H subsystem may receive the “Request for Documentation Form” and the associated required documents including the lease, riders to the lease (if applicable), W-9 for the landlord and each broker/agent, the landlord's name, phone number and email address, attorney's name, phone number and email address (if applicable), broker(s)-name, phone and email address (if applicable), and check the documents to confirm they are complete, and store the documents in the claims database 131 in association with the claim 352. The H/H subsystem may additionally generate and store a W-9 tax form for the property manager.

At step 288, the H/H subsystem may then review a draft of the lease for compliance with various checkpoints and requirements. For example, the H/H subsystem may include checkpoints and requirements, such as: Is the lease header complete and legible with the landlord and tenant's full name and address? Is the interim address complete and legible including street designations, unit numbers, and zip codes? Is the lease start date accurate? Is the lease end date accurate? Do all parties whom checks are to made payable to have a W9 on file or have submitted a W9 with the lease draft? Does the name and payment address for each party match the name and address on their W9? Does the rental rate, security deposit, all one-time fees including broker commission match the dollar amounts submitted to the CEM 102? If there are pets, does the lease clearly and accurately reflect the agreed upon terms for the pets? Does the lease clearly and accurately reflect all appliances that are to be included in the rental rate? Does the lease clearly and accurately reflect any utility services that are to be included in the rental rate? Does the lease clearly and accurately reflect any maintenance services that are to be included in the rental rate i.e. snow removal, landscaping, housekeeping, etc.? Does the lease require a method of payment other than the customary mailed monthly rent check? Examples of such payment would be electronic bank transfers, money orders or credit card payment. Is the paragraph describing reimbursement of security deposit written to reflect the tenant's best interests? Does the paragraph describing Tenant's Maintenance Responsibilities include any unauthorized responsibilities such as service maintenance contracts or liability for damages caused by anything other than tenant's misuse or neglect? Does the paragraph describing Landlord's Right to Entry include a 24 hour or greater notification be sent to tenant except in circumstances of emergency? Does the paragraph describing the tenant's responsibility to make the house available to be shown to prospective buyers or renters comply with the terms previously negotiated and submitted to the CEM 102? Is the LOU specific month-to-month phrasing written or typed clearly and legibly on the lease or an amendment? Are all other requested specific phrases pertaining to special circumstances (ex. restricted areas and/or amenities), make ready criteria (ex. Professional cleaning), Landlord/requested contractor modifications (ex. Yard fencing, ramp installation) written or typed clearly and legibly on the lease? Does the Insurance Carrier or other non-insured persons 101 appear anywhere on the lease or are either referenced as an additional lessee or guarantor?

In an embodiment, the H/H subsystem or customer experience subsystem 112 may automatically check the lease for compliance with the checkpoints by electronically comparing the relevant clauses of the lease to template clauses to ensure the presence or absence of desired clauses. In another embodiment, the H/H subsystem may present the lease to the H/H coordinator 104 via the H/H user interface 121 along with a series of prompts that describe each checkpoint and require a confirmation that the lease complies with the prompt. For example, the H/H user interface 121 may present a wizard screen 400 with each checkpoint presented as a question 406 and each confirmation received as an answer. The H/H user interface 121 may store a record of the confirmations in the claims database 131 in association with the lease and the claim 352.

At step 290, if, after review, modifications to the lease are required, the H/H coordinator 104 may set a calendar alert for the CEM 102 notifying the CEM 102 of the need for modifications. At step 292, the H/H coordinator 104 may then notify the property manager of the desired modifications by revising the lease and sending the property manager the proposed changes. At step 294, the H/H coordinator 104 may additionally set a calendar alert for the accounting coordinator 106 to review the lease draft, all search notes and log notes. The H/H coordinator 104 may also set a calendar alert for the CEM 102 notifying the CEM 102 that the lease draft is has been forwarded to the accounting subsystem 116 for final review and approval. At step 296, the accounting coordinator 106 may review the lease. If the accounting coordinator 106 signs off on the lease, he or she may record the approval by notifying the H/H coordinator 104. Alternatively, if the accounting coordinator 106 identifies issues with the lease, the accounting coordinator 106 may create a calendar task for the H/H coordinator 104 to fix the identified issues.

At step 298, if the property manager refuses the changes, the H/H coordinator 104 may set a calendar alert for the CEM 102 to resolve the issues with the lease. At step 300, the CEM 102 may review the lease and determine whether to request modification, accept the lease as-is, or secure alternate housing. Once the lease is finalized, at step 302, the CEM 102 may request approval of the costs and lease term from the adjuster 103. At step 304, the adjuster 103 may approve the costs and lease terms for the request. At step 306, the customer experience subsystem 112 may store the acceptance by the adjuster 103 in the claim database in association with the claims 352 using the documents screen. After the adjuster's approval, the H/H coordinator 104 may schedule a time with the insured persons 101 and the property manager to execute the lease. For example, the H/H coordinator 104 may email a proposed time to the insured persons 101 and the property manager.

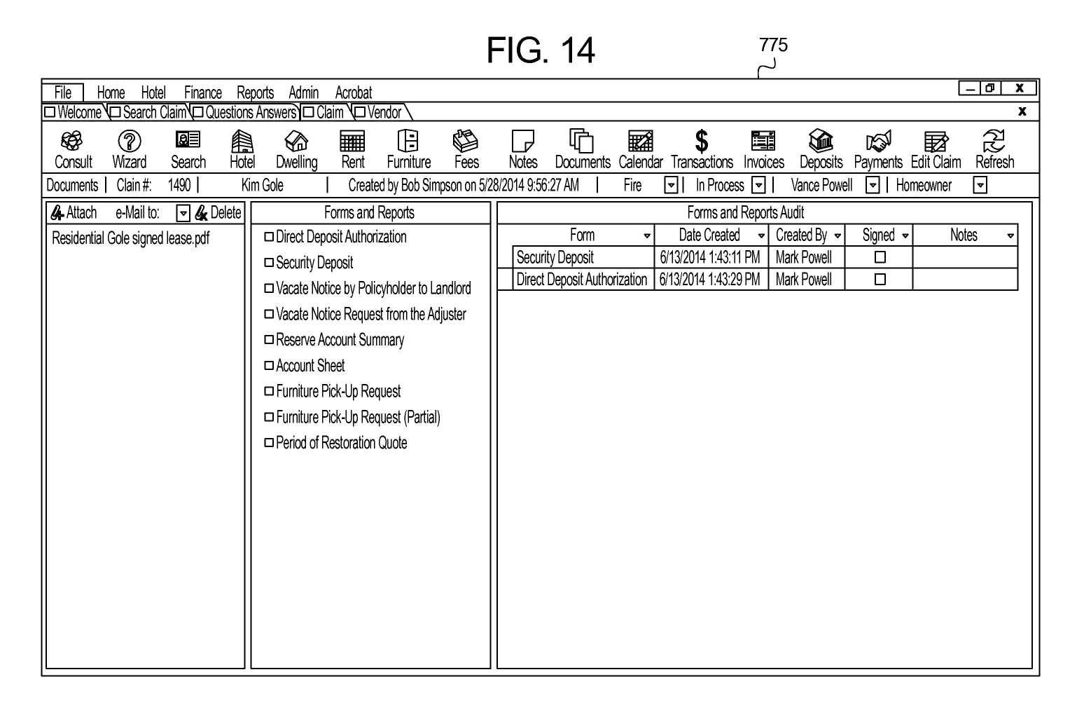

A documents screen 775, shown in FIG. 14, may inventory all documents associated with the claim 352 in the claims database 131. The documents screen may permit a user to access any document stored with the claim 352 by clicking on the name of the document. Additionally, users may upload documents for storage in association with the claim 352. Alternatively, documents may be automatically generated or edited by the claims processing system 100 by populating document templates with the stored claim information. A listing of forms and reports in the documents screen may include the name of the form, the date created, created by, a checkbox indicating the document is signed, and text notes. Hotel and accounting notes that have sensitive financial information may be marked “Private” such that only the accounting coordinator 106 may view the notes.

At step 308, the H/H coordinator 104 may confirm the security deposit payment method (either paid by the insured persons 101 or the claim processing system 100) and request, at step 310, that move-in funds be sent by the accounting coordinator 106 to the property manager. Having completed all of her hotel and housing tasks, at step 312 the H/H coordinator 104 may then request payment for the assignment from the customer experience manager.

At step 314, the customer experience subsystem 112 may then generate a furniture order. The CEM 102 may set a calendar alert for the H/H coordinator 104 to find a furniture vendor 105 for the chosen housing. At step 316, the CEM 102 may additionally request approval from the adjuster 103 for the furniture costs. The CEM 102 may store an approval confirmation from the adjustor (for example, by saving an image of the email).

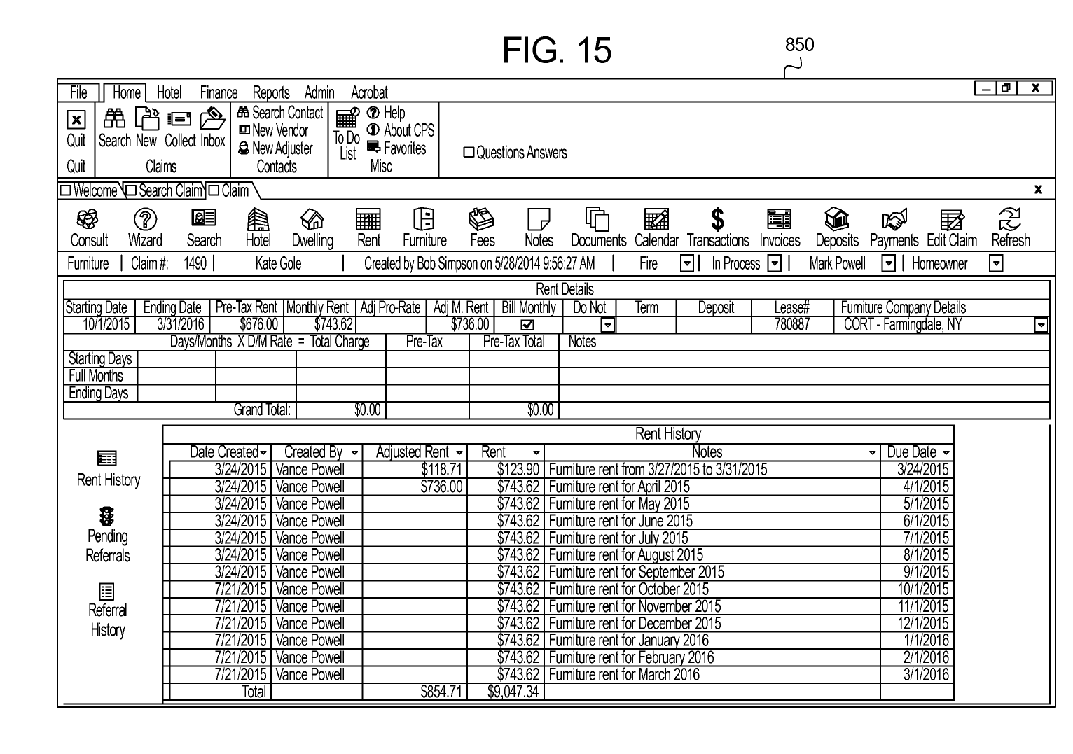

In an embodiment shown in FIG. 15, a furniture screen 850 may display the rental details for the chosen furniture supplier. The furniture screen may include furniture rental details and a furniture rental history including past and future rental payments. Furniture rental details may include the start date of the lease, ending date of the lease, monthly rent of the furniture, adjusted pro-rate, adjusted monthly rent, a checkbox to indicate whether the lease is billed monthly, a do not pay dropdown box (to indicate alternate payment options), term, deposit, lease number, furniture company detail, and calculator to illustrate the pro-rata rent calculation. The do not pay dropdown box may be used to indicate whether a retail rate is to be paid or if it is only to be used to calculate shared savings. By marking “Do Not Pay” in the do not pay dropdown box, the payment is applied to the adjusted month rent rather than the monthly rent.

The furniture rent history may include a list of past and expected rental payments calculated from the furniture rental details. Each payment may include a date created, the person who created the payment, the adjusted rent, the rent, notes regarding the payment, and the due date.

On the day of move-in, the customer experience subsystem 112 may contact the insured persons 101 to ensure that the move-in occurred. For example, the customer experience subsystem 112 may prompt the CEM 102 to call the insured persons 101 to determine that the move-in occurred. The CEM 102 may record the move-in using the CEM user interface 121, for example, using the Log Notes on the Dwelling screen. The CEM 102 or the adjuster subsystem may then notify the adjuster 103 that the move-in occurred. The notification may be stored in the claims database 131 in association with the claim 352. At step 322, the CEM 102 may make a courtesy call to the insured persons 101 and the adjuster 103 to confirm satisfaction with the process.

At step 324, the accounting coordinator 106 may enter all the cost for the dwelling, furniture, recurring fees and one-time fees into the accounting user interface 121. After the lease is secured, at step 326, the accounting coordinator 106 may issue move-in funds including broker's fees, landlord's pro-rate, first month's rent, pet fee, etc. To begin payment for the Schedule D services, at step 328, the accounting coordinator 106 may generate an initial adjustor invoice and send it to the adjustor for payment. Payment may be made directly by the adjuster 103 to the vendor 105, by the claims processing system 100 using the stored payment details of the adjuster 103, or by the claims processing system 100 on behalf of the adjuster 103.

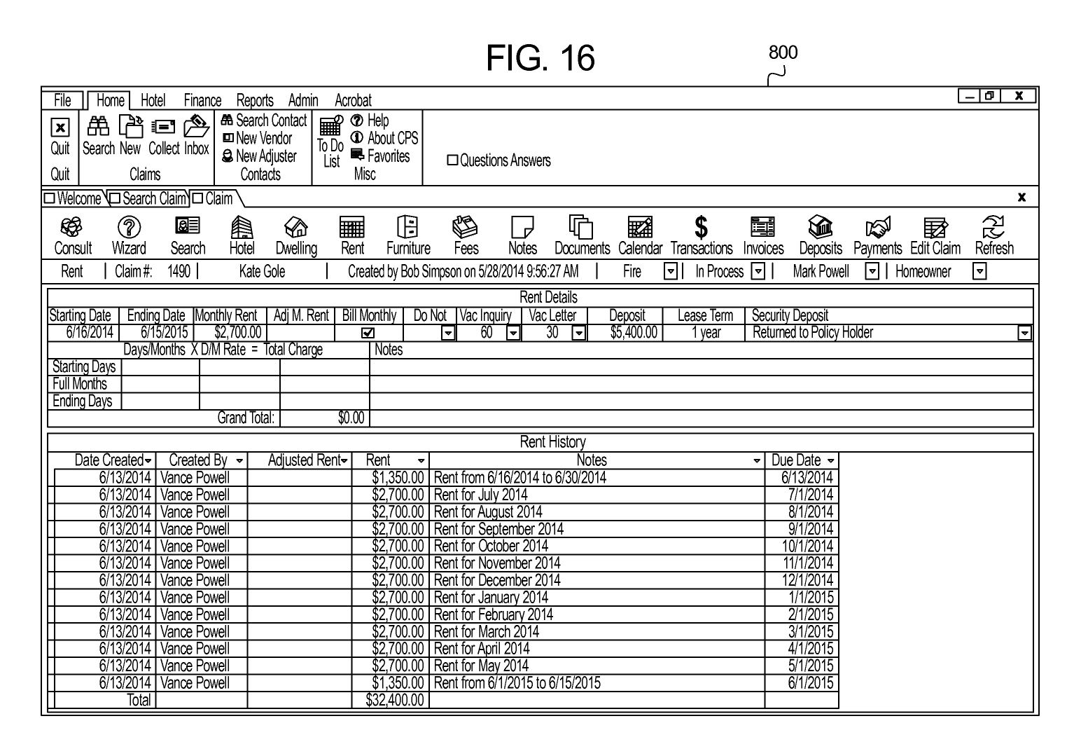

In an embodiment shown in FIG. 16, a rent screen 800 may display the rent details for the chosen housing option for a claim 352. The rent screen 800 may include rental details and a rental history including past and future rental payments. Rental details may include the start date of the lease, ending date of the lease, lease start date and end date, monthly rent, adjusted monthly rent, a checkbox to indicate whether the lease is billed monthly, a do not pay—do not invoice dropdown box, a number of days for a vacate inquiry, a number of days for a vacate letter, a required deposit, the lease term, a security deposit disposition dropdown box, and calculator to illustrate the pro-rata rent calculation. The rent history may include a list of past and expected rental payments calculated from the rental details. Each payment may include a date created, the person who created the payment, the adjusted rent, the rent, notes regarding the payment, and the due date.

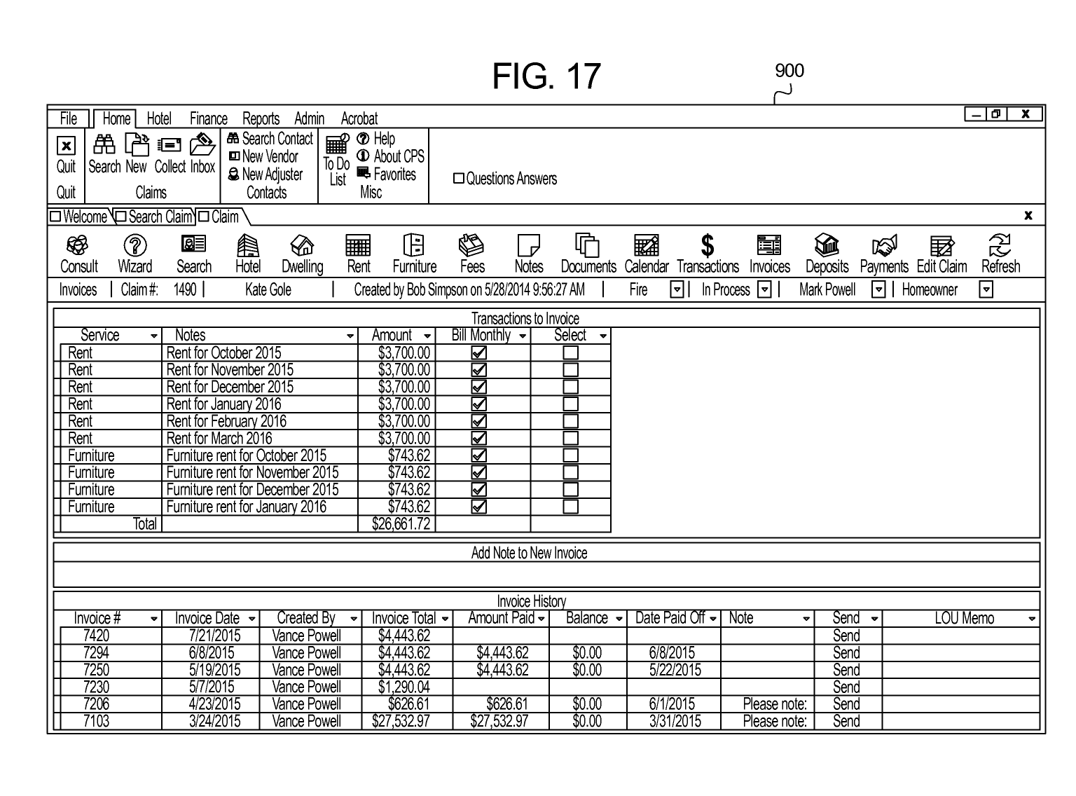

During the life of the lease, at step 330, the accounting subsystem 116 may generate monthly invoices and send to adjustor for payment. As shown in FIG. 17, an invoices screen 900 permits the accounting coordinator 106 to invoice transactions relating to a claim 352 to the adjuster 103. Transactions may be automatically generated based on the terms of leases associated with the claim 352. Each transaction in a transaction list may include the service type of the transaction (rent, furniture, hotel, etc.), notes about the service, the amount, a selection box indicating that the service is billed monthly, and a selection box to include a transaction in an invoice. The accounting coordinator 106 may select the selection boxes desired and click the generate invoice button. An invoice history box may display a list of invoices that have been created by the claims processing system 100. For each invoice, the list of invoices may include an invoice number, an invoice date, created by, an invoice total, an amount paid, a balance, a paid off date, text notes, and memo notes. Additionally, each invoice may include a note listing any discounts obtained by the claims processing system 100. For example, an invoice may list the retail rate for the services and a discounted rate or discount amount. A portion of the savings discounted rate or discounted amount may be included on the invoice for payment to the claims processing system 100 as compensation for the discounted rate.

If the claims processing system 100 makes payments on behalf of the adjuster 103, the accounting subsystem 116 may process incoming payments from the adjuster 103, for example, at step 332, the accounting coordinator 106 may deposit checks as payments are received.

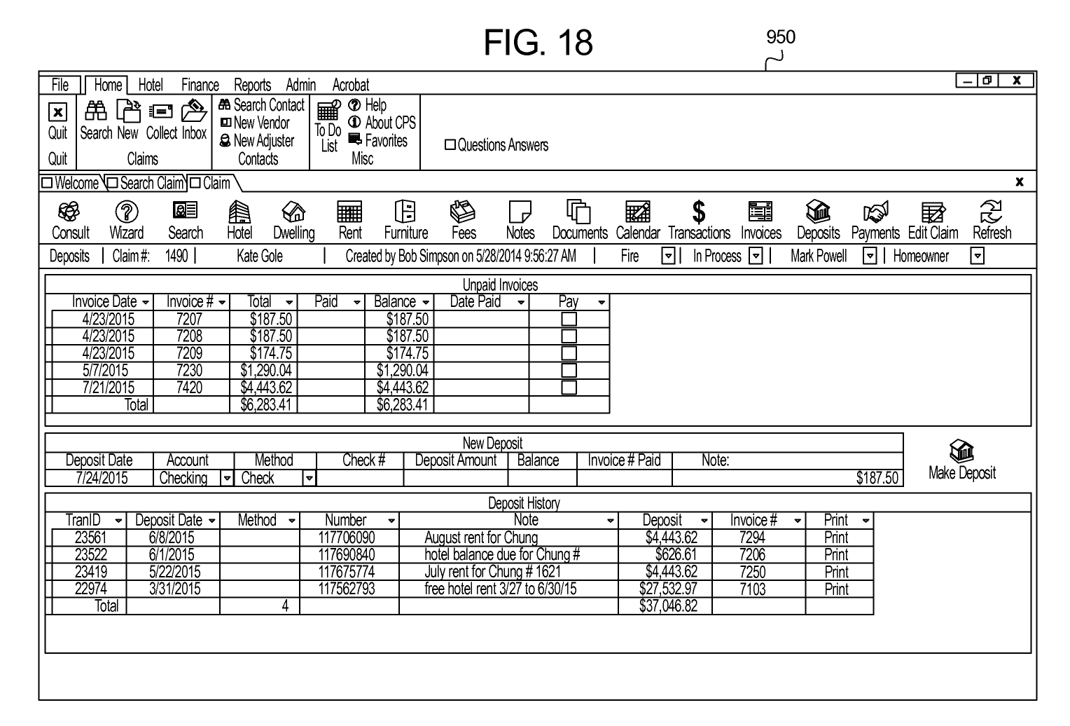

Turning to FIG. 18, a deposits screen 950 may be used by the accounting coordinator 106 to track deposits and payments to the claims processing system 100 made on invoices. As shown, the deposits screen may include a list of unpaid invoices, a new deposit form, and a deposit history. The list of unpaid invoices may include fields for the invoice date, the invoice number, the total amount deposited, the amount paid, the balance remaining after the amount paid, the date paid, and a pay checkbox to enter a deposit on an invoice. When a new deposit comes in, the accounting coordinator 106 may click the pay checkbox on the appropriate invoice and fill out the new deposit form. The new deposit form may include fields for the deposit date, the account in which the deposit was received, the method of receiving the deposit, the check number, if appropriate, the deposit amount, the balance (this may be auto-filled), the invoice number paid (this may be auto-filled from the pay box selection), and note text. Once the deposit information is entered, the accounting coordinator 106 may click the “make deposit” screen to record the deposit. The deposit may then be displayed in the deposit history. The deposit history may include fields such as the transaction ID, the deposit date, the deposit method, note text, the deposit amount, the invoice number, and a button to print a record of the deposit.

Using the received funds from deposits, the accounting subsystem 116 may, in turn at step 334, generate monthly rent checks for the dwelling and rental furniture.

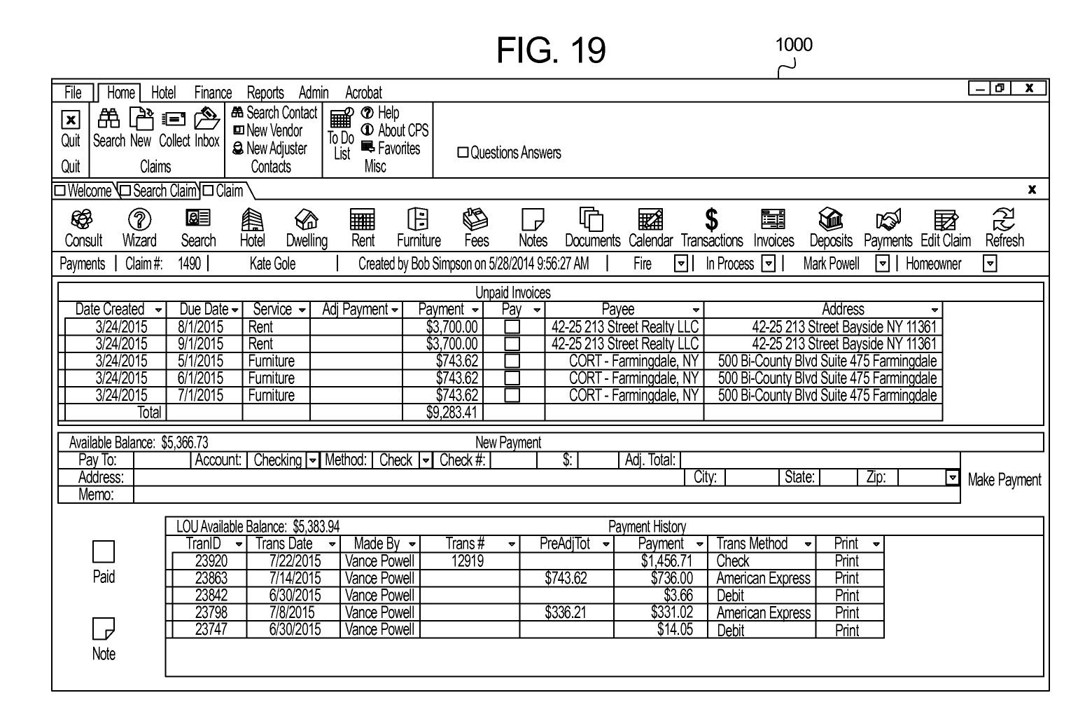

In an embodiment shown in FIG. 19, a payments screen 1000 may be used by the accounting coordinator 106 to track payments to be made to vendors 105. This is needed when payments to vendors 105 are being made by the claims processing system 100 rather than directly by the vendor 105 or the insured.

As shown, the payments screen may include a list of unpaid items, a new payment form, and a payment history. The list of unpaid invoices may include fields for the date created, the due date, the service type, the adjusted payment amount, the payment amount, a pay checkbox to enter a payment on an invoice, the payee, and the payee's address. When a new payment is to be made, the accounting coordinator 106 may select the pay box on the appropriate unpaid item and fill out the new payment form.

The new payment form may include fields for the payee, the account that the money is to be drawn from, the method of payment, the check number, if applicable, the amount, and adjusted total, the address, city, state, and zip code the payment is to be made to, and memo text. The accounting coordinator 106 may consolidate several payments to a single vendor 105 by clicking the appropriate pay checkboxes and clicking a sum transactions button. The accounting user interface 121 will then automatically populate the pay to, amount, adjusted amount, and address fields. When the new payment information is correct, the accounting coordinator 106 may click the make payment button to initiate the payment process to the vendor 105.

The payment may then be displayed in the payment history. The payment history may include fields such as the transaction ID, the transaction date, a made by user who initiated the transaction, the transaction number, the pre-adjusted total, the payment amount, the transaction method, and a button to print a record of the payment.

In an embodiment, the pre-adjusted total reflects a retail rate before any discounts or rebates are applied, and the payment amount reflects the total after accounting for the discounts and rebates. The difference between the pre-adjusted total and the payment amount reflects savings generated by the claims processing system 100. The claims processing system 100 may bill the adjuster 103 for a portion of the savings as a part of a shared savings model to incentivize discounts obtained by the claims processing system 100.

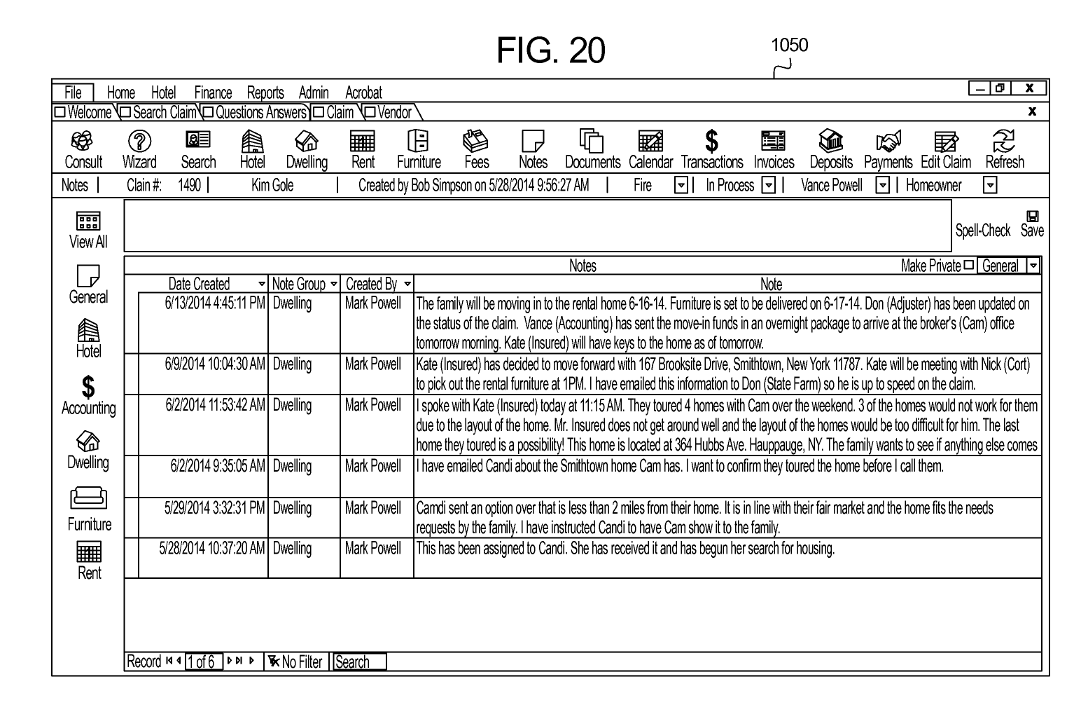

In an embodiment shown in FIG. 20, a notes screen 1050 may include a record of all the actions taken for a claim 352. The notes screen may include a listing of notes, where the listing of notes includes sortable categories for each note, such as: a date created; a note category (including, for example, general, hotel, accounting, dwelling, furniture, and rent); created by (the user who created the note) and note text.

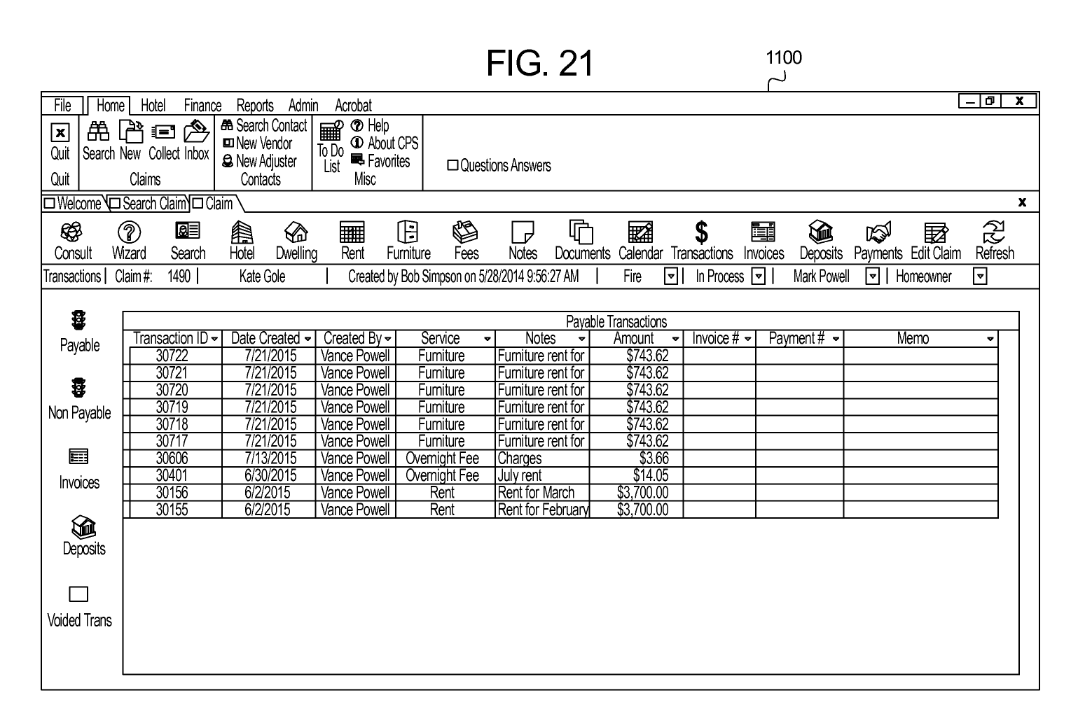

In an embodiment shown in FIG. 21, a transactions screen 1100 may list all the transactions created for a claim 352. For each transaction, the transactions screen may include: a transaction ID; a date created; created by; a service type (Hotel, Rent, Furniture, Appliance rental, blinds, broker, overnight fee, deposit, voided, etc.); text notes; an amount; an invoice number, a payment number; and memo text. The transactions list may be limited by a payable transactions button for payable transactions, a non-payable button for non-payable transactions, an invoices button for invoiced transactions, a deposits button to view deposits, and a voided transactions button to view voided transactions.

When the lease term is nearly over, at step 336, the accounting coordinator 106 may follow up with insured on vacate status for temporary housing. If an extension is needed, at step 338, the accounting coordinator 106 may send the adjustor a notice or extension request. At step 340, the adjuster 103 may then grant or deny the extension request via the adjuster user interface 121. The accounting subsystem 116 may store confirmation of the extension granted or denial at step 342. If the extension is granted, at step 344, the accounting coordinator 106 may notify the property manager of extension granted. When the extension is denied, at step 346, the accounting coordinator 106 may contact insured and send them a vacate notice to give the landlord.

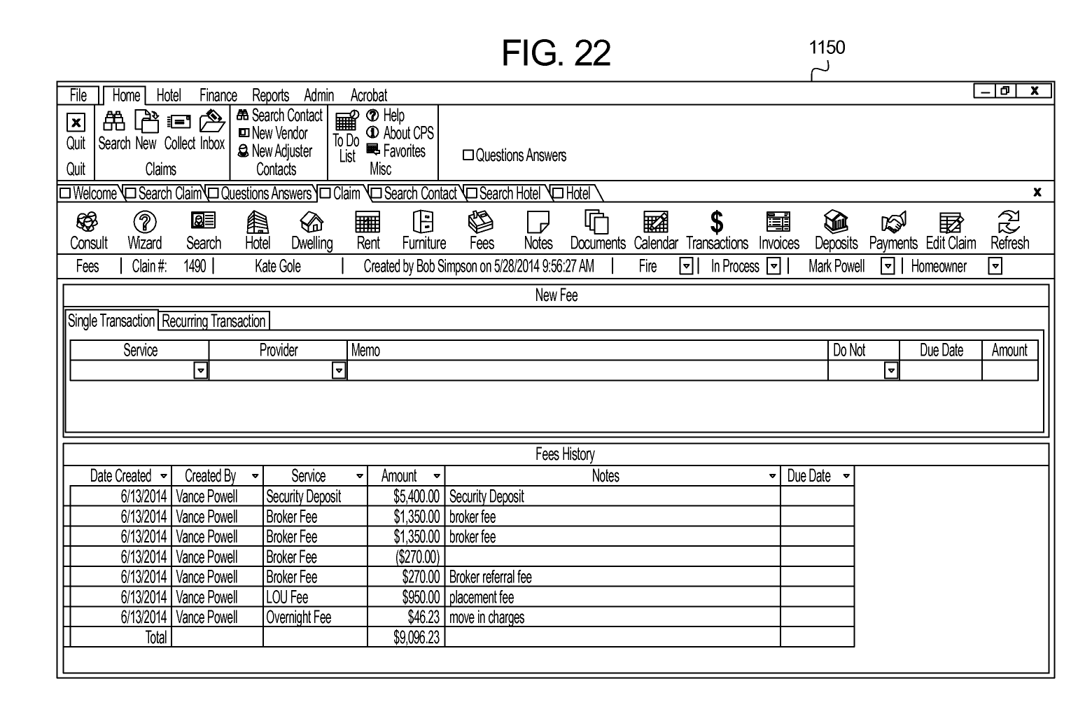

As shown in FIG. 22, in an embodiment, a fees screen 1150 may be provided to create and view fees for a claim 352. The fee screen may include a new fee input box and a fee history. A user may input the service (standard claim fee, furniture delivery fee, broker fee, blinds fee, overnight fee, appliance fee, etc.), the provider, memo text, a Do Not field to note if the fee should or should not be invoiced, a due date, and an amount. The fee history may include a list of fees. For each fee, the fee history may include the date created, the created by user, the amount of the fee, the memo text, and the due date, if any.

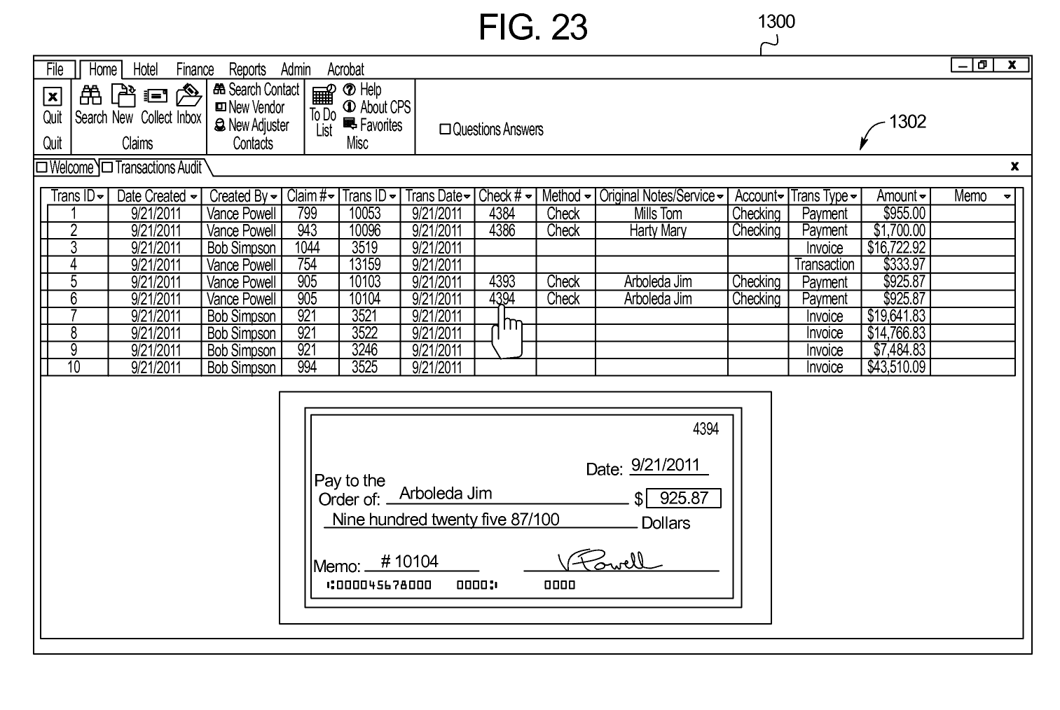

In an embodiment shown in FIG. 23, a corporate claim user interface 127 may include an audit screen 1300 to permit the insurance company 107 to audit the payments on a claim 352. As shown in FIG. 23, the audit screen 1300 may include a listing of transactions 1302. For each transaction, the audit screen 1300 may include a transaction ID, a transaction date, a payment method, notes, an amount of the transaction, etc. In some embodiments, the audit may include a retail rate representing the cost before discounts quoted by the vendor 105, and a discounted rate that was actually paid due to discounts generated by the claims processing system 100. The audit screen 1300 may also include a link to access stored checks, vendor invoices, and other documentation of the retail rate and the discounted rate. As shown, a user may click a check number to view the check for a payment made by or received by the claims processing system. The audit screen may additionally provide an accounting of all payments made by the claims processing system on behalf of the insurance company 107, all payments made by the claims processing system using payment credentials provided by the insurance company 107, etc.

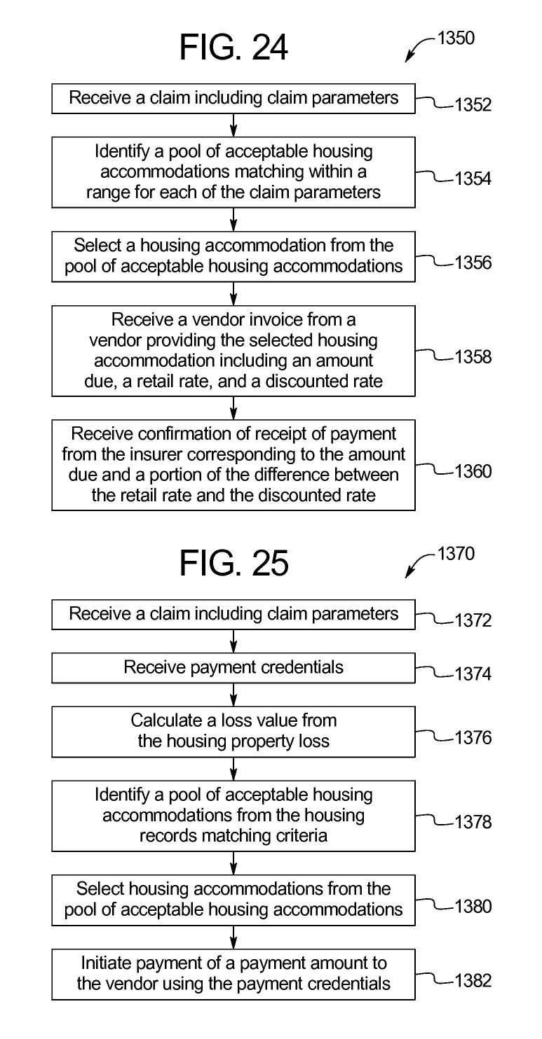

In an embodiment, a claims processing system 100 for processing an insurance claim 352 for a housing property loss insured by an insurance company 107 includes a controller 140 and a memory 150 in communication with the controller 140, the memory 150 including instructions that, when executed by the controller 140, cause the controller 140 to execute a claim processing method 1350 of FIG. 24.

As shown in FIG. 24, in an embodiment, the claim processing method 1350 causes the controller 140 to: at step 1352, receive a claim 352, the claim 352 including claim parameters including an anticipated lease term, a location related to the housing property loss, a loss value, and a number of people to be housed; at step 1354, identify a pool of acceptable housing accommodations matching within a range for each of the claim parameters; at step 1356, select a housing accommodation from the pool of acceptable housing accommodations; at step 1358, receive a vendor invoice from a vendor 105 providing the selected housing accommodation including an amount due, a retail rate, and a discounted rate; and, at step 1360, receive confirmation of receipt of payment from the insurer corresponding to the amount due and a portion of the difference between the retail rate and the discounted rate.

In some embodiments, the claim 352 is received from a customer experience subsystem 112. In other embodiments, the claim 352 is received from an adjuster subsystem.

In some embodiments, the claim 352 parameters further include a number of bedrooms, wherein the pool of acceptable housing accommodations includes only housing accommodations including, at a minimum, the number of bedrooms. In some embodiments, the claim 352 parameters further include a number of baths, wherein the pool of acceptable housing accommodations includes only housing accommodations including, at a minimum, the number of baths. In some embodiments, the claim 352 parameters further include a maximum acceptable distance from the location, wherein the pool of acceptable housing accommodations includes only housing accommodations within the maximum acceptable distance from the location.

In some embodiments, the housing accommodations are selected by providing a list to a policyholder and receiving a selection from the policyholder. In some embodiments, the housing accommodations are selected by providing a list to an adjuster 103 and receiving a selection from the adjuster 103. In some embodiments, the housing accommodations are selected on a lowest cost basis. In some embodiments, the housing accommodations are selected on the basis of the shortest distance between the housing accommodation and the location.

In some embodiments, a best match algorithm selects the housing accommodations. For example, in an embodiment, a best match method may select a housing option that is within a predetermined range from the loss, has a maximum occupancy greater than the number of insured persons 101, has an equivalent or greater number of bedrooms and bathrooms, and is pet-friendly if the insured persons 101 have pets. In an embodiment, the predetermined range is five miles.

In some embodiments, the discounted rate is expressed as a percentage of the retail rate. In some embodiments, the discounted rate is expressed as an absolute number amount.

In some embodiments, the pool of acceptable housing accommodations includes an availability term that is equal to or greater than the lease term. In some embodiments, the location related to the housing property loss is the actual location where the loss occurred. In some embodiments, the location related to the housing property loss is a policyholder selection of a location. In some embodiments, the housing accommodation includes a selection of a hotel and a rental housing.

In an embodiment, a claims processing system 100 for processing an insurance claim 352 for a housing property loss insured by an insurer includes: a housing database 133 including a plurality of housing records, each housing record identifying a rental term, a rental location, a rent amount, and a maximum occupancy; a controller; and a memory in communication with the controller 140, the memory including instructions that, when executed by the controller 140, cause the controller 140 to execute a claim processing method 1370 of FIG. 25.

As shown in FIG. 25, in an embodiment, the claim processing method 1370 causes the controller 140 to: at step 1372, receive the claim 352, the claim 352 including claim parameters including a term, a location related to the housing property loss, and a number of persons to be housed; at step 1374, receive payment credentials via an adjuster user interface 121; calculate a loss value from the housing property loss; at step 1376, identify a pool of acceptable housing accommodations from the housing records matching criteria including the rental term is equal to or greater than the term, the rental location is within a range of the location related to the housing property loss, the number of persons to be housed is less than the maximum occupancy, and the rent is within a range of the loss value; at step 1380, select housing accommodations from the pool of acceptable housing accommodations, the housing accommodates being provided by a vendor 105; and, at step 1382, initiate payment of a payment amount to the vendor 105 using the payment credentials.

In an embodiment, the range of the location related to the housing property loss is up to five miles from the actual location where the loss occurred. In an embodiment, the range of the loss value is a range centered on the loss value of a range amount, wherein the range amount is between zero and five hundred dollars.

It should be noted that various changes and modifications to the presently preferred embodiments described herein will be apparent to those skilled in the art. Such changes and modifications may be made without departing from the spirit and scope of the present invention and without diminishing its attendant advantages.

1. A claims processing system for processing an insurance claim for a housing property loss insured by an insurer comprising:
a controller; and
a memory in communication with the controller, the memory including instructions that, when executed by the controller, cause the controller to:
receive a claim, the claim including claim parameters including an anticipated lease term, a location related to the housing property loss, a loss value, and a number of people to be housed;
identify a pool of acceptable housing accommodations matching within a range for each of the claim parameters;
select a housing accommodation from the pool of acceptable housing accommodations;
receive a vendor invoice from a vendor providing the selected housing accommodation including: an amount due, a retail rate, and a discounted rate; and
receive confirmation of receipt of payment from the insurer corresponding to the amount due and a portion of the difference between the retail rate and the discounted rate.

2. The claims processing system of claim 1, wherein the claim is received from a customer experience subsystem.

3. The claims processing system of claim 1, wherein the claim is received from an adjuster subsystem.

4. The claims processing system of claim 1, wherein the claim parameters further include a number of bedrooms, wherein the pool of acceptable housing accommodations includes only housing accommodations including, at a minimum, the number of bedrooms.

5. The claims processing system of claim 1, wherein the claim parameters further include a number of baths, wherein the pool of acceptable housing accommodations includes only housing accommodations including, at a minimum, the number of baths.

6. The claims processing system of claim 1, wherein the claim parameters further include a maximum acceptable distance from the location, wherein the pool of acceptable housing accommodations includes only housing accommodations within the maximum acceptable distance from the location.

7. The claims processing system of claim 1, wherein the housing accommodations are selected by providing a list to a policyholder and receiving a selection from the policyholder.

8. The claims processing system of claim 1, wherein the housing accommodations are selected by providing a list to an adjuster and receiving a selection from the adjuster.

9. The claims processing system of claim 1, wherein the housing accommodations are selected by a best match algorithm.

10. The claims processing system of claim 1, wherein the housing accommodations are selected on a lowest cost basis.

11. The claims processing system of claim 1, wherein the housing accommodations are selected on the basis of the shortest distance between the housing accommodation and the location.

12. The claims processing system of claim 1, wherein the discounted rate is expressed as a percentage of the retail rate.

13. The claims processing system of claim 1, wherein the discounted rate is expressed as an absolute number amount.

14. The claims processing system of claim 1, wherein the pool of acceptable housing accommodations includes an availability term that is equal to or greater than the lease term.

15. The claims processing system of claim 1, wherein the location related to the housing property loss is the actual location where the loss occurred.

16. The claims processing system of claim 1, wherein the location related to the housing property loss is a policyholder selection of a location.

17. The claims processing system of claim 1, wherein the housing accommodation includes a selection of a hotel and a rental housing.

18. A claims processing system for processing an insurance claim for a housing property loss insured by an insurer comprising:
a housing database including a plurality of housing records, each housing record identifying a rental term, a rental location, a rent amount, and a maximum occupancy;
a controller; and
a memory in communication with the controller, the memory including instructions that, when executed by the controller, cause the controller to:
receive the claim, the claim including claim parameters including a term, a location related to the housing property loss, and a number of persons to be housed;
receive payment credentials via an adjuster user interface;
calculate a loss value from the housing property loss;
identify a pool of acceptable housing accommodations from the housing records matching criteria including the rental term is equal to or greater than the term, the rental location is within a range of the location related to the housing property loss, the number of persons to be housed is less than the maximum occupancy, and the rent is within a range of the loss value;
select housing accommodations from the pool of acceptable housing accommodations, the housing accommodates being provided by a vendor; and
initiate payment of a payment amount to the vendor using the payment credentials.

19. The claims processing system of claim 18, wherein the range of the location related to the housing property loss is up to five miles from the actual location where the loss occurred.

20. The claims processing system of claim 18, wherein the range of the loss value is a range centered around the loss value of a range amount, wherein the range amount is between zero and five hundred dollars.
